(19) United States
(12) Patent Application Publication
(10) Pub. No.: US 2025/0229444 A1
(43) Pub. Date: Jul. 17, 2025

(54) DEVICES CONFIGURED TO OPERATE ON AN ANGLED SURFACE, AND ASSOCIATED SYSTEMS AND METHODS

(71) Applicant: Renovate Robotics, Inc., Spokane, WA (US)

(72) Inventors: Andrew Stulc, New York, NY (US); Taylor Nicholson, Brooklyn, NY (US); James Schwartz, New York, NY (US); Thomas Forsyth, New York, NY (US); Aishwarya Ravindran, Brooklyn, NY (US); Kristen Young, New York, NY (US)

(21) Appl. No.: 19/016,648

(22) Filed: Jan. 10, 2025

Related U.S. Application Data
(60) Provisional application No. 63/620,145, filed on Jan. 11, 2024.

(51) Int. Cl. B25J 19/06; B25J 5/00; E04D 15/04; E04D 15/07

(52) U.S. Cl. CPC B25J 19/06; B25J 5/007; E04D 15/04; E04D 15/07

(57) ABSTRACT

Apparatuses configured to operate on an angled surface and associated systems and methods are disclosed herein. In some embodiments, an apparatus includes a body assembly, an arm assembly, and an end effector assembly. The body assembly can include a body portion, one or more wheels, one or more motors coupled to corresponding ones of the one or more wheels, and a plurality of cable connectors coupled to the rail. Individual ones of the cable connectors are configured to be coupled to corresponding cables. The arm assembly can be coupled to the body portion of the body assembly and can include a retriever. The end effector assembly can be releasably coupled to the retriever of the arm assembly and configured to carry a surface material.

### CROSS-REFERENCE TO RELATED APPLICATIONS

The present application claims the benefit of U.S. Provisional Patent Application No. 63/620,145, filed Jan. 11, 2024, the disclosure of which is incorporated herein by reference in its entirety.

### TECHNICAL FIELD

This present disclosure relates to devices configured to operate on an angled surface, and associated systems and methods. Some embodiments relate to devices configured to operate on a roof or similar structure to perform automated activities such as installing shingles.

### BACKGROUND

The number of new buildings constructed has significantly increased over the past few decades. Moreover, the amount of climate-related damage to existing buildings and infrastructure continues to grow, which has increased demand for construction labor. However, construction jobs can be repetitive, low-paying, and dangerous, leading to labor shortages in the industry. Roof installation and maintenance, for example, can be a slow and labor-intensive process, requiring various materials such as shingles to be transported from the ground to the roof and individually installed. There is also increasing demand for installing solar panels on residential and commercial roofs, yet such installations and maintenance remain mostly manual. There is a need to automate the management of roofs and other surfaces of structures.

### BRIEF DESCRIPTION OF THE DRAWINGS

Features, aspects, and advantages of the presently disclosed technology may be better understood with regard to the following drawings.

FIG. 1 is a schematic view of a system for operating an apparatus and anchor assemblies on an angled surface, configured in accordance with embodiments of the present technology.

FIG. 2A is a schematic of the apparatus of FIG. 1, configured in accordance with embodiments of the present technology.

FIG. 2B is a schematic of one of the anchor assemblies of FIG. 1, configured in accordance with embodiments of the present technology.

FIG. 3 is a perspective view of a system for operating an apparatus on an angled surface, configured in accordance with embodiments of the present technology.

FIG. 4 is a perspective view of an apparatus that can be operated on an angled surface, configured in accordance with embodiments of the present technology.

FIG. 5 is a top view of a body of the apparatus of FIG. 4, configured in accordance with embodiments of the present technology.

FIG. 6 is a side view of the apparatus of FIG. 4, configured in accordance with embodiments of the present technology.

FIG. 7 is a perspective view of a hopper of the apparatus of FIG. 4, configured in accordance with embodiments of the present technology.

FIGS. 8A and 8B are perspective and enlarged perspective views of a spacer, configured in accordance with embodiments of the present technology.

FIG. 9 is a perspective view of a material handling assembly of the apparatus of FIG. 4, configured in accordance with embodiments of the present technology.

FIG. 10 is a perspective view of a portion of the material handling assembly of FIG. 9, configured in accordance with embodiments of the present technology.

FIG. 11 is an enlarged side view of a gripper of the material handling assembly of FIG. 9, configured in accordance with embodiments of the present technology.

FIG. 12 is an enlarged side view of a surface detector of the material handling assembly of FIG. 9, configured in accordance with embodiments of the present technology.

FIG. 13 is a partially cross-sectional view of the material handling assembly of FIG. 9, configured in accordance with embodiments of the present technology.

FIGS. 14 and 15 are perspective views of components of a nail gun assembly of the material handling assembly of FIG. 9, configured in accordance with embodiments of the present technology.

FIG. 16 is a cross-sectional view of the nail gun assembly of FIGS. 14 and 15 in an assembled state.

FIG. 17 is a perspective view of an anchor assembly, configured in accordance with embodiments of the present technology.

FIG. 18 is a perspective view of a base plate of the anchor assembly of FIG. 17, configured in accordance with embodiments of the present technology.

FIG. 19 is a perspective view of the anchor assembly of FIG. 17 with a housing rendered at least partially transparent for illustrative purposes.

FIG. 20 is a cross-sectional view of the anchor assembly of FIG. 17, configured in accordance with embodiments of the present technology.

FIG. 21 is a perspective view of a system for operating an apparatus on an angled surface, configured in accordance with embodiments of the present technology.

FIGS. 22A and 22B are front perspective and rear perspective views, respectively, of an apparatus that can be operated on an angled surface, configured in accordance with embodiments of the present technology.

FIGS. 23A and 23B are top perspective and bottom perspective views, respectively, of a body assembly of the apparatus of FIG. 22A, configured in accordance with embodiments of the present technology.

FIGS. 24A and 24B are top perspective and bottom perspective views, respectively, of a hopper assembly of the apparatus of FIG. 22A, configured in accordance with embodiments of the present technology.

FIG. 25 is an enlarged perspective view of the hopper assembly of FIG. 24A.

FIG. 26 is a bottom perspective view of an arm assembly of the apparatus of FIG. 22A, configured in accordance with embodiments of the present technology.

FIG. 27 is a perspective view of an end effector assembly of the apparatus of FIG. 22A, configured in accordance with embodiments of the present technology.

FIG. 28 is an enlarged perspective view of the end effector assembly of FIG. 27.

FIG. 29 is a perspective cutaway view of the end effector assembly of FIG. 27 along plane 29-29 in FIG. 27.

FIG. 30 illustrates operation of the apparatus of FIG. 22A, in accordance with embodiments of the present technology.

FIGS. 31A and 31B are perspective and top views, respectively, of an anchor assembly, configured in accordance with embodiments of the present technology.

FIG. 32 is a cross-sectional view of the anchor assembly of FIG. 31A along plane 32-32 in FIG. 31B.

FIG. 33 is a flowchart illustrating a method of operating an apparatus to place surface materials on an angled surface in accordance with some embodiments of the present technology.

FIG. 34 is a flowchart illustrating a method of operating an apparatus and anchor assemblies to place surface materials on an angled surface in accordance with some embodiments of the present technology.

FIG. 35 is a block diagram that illustrates an example of a computer system in which at least some operations described herein can be implemented.

A person skilled in the relevant art will understand that the features shown in the drawings are for purposes of illustrations, and variations, including different and/or additional features and arrangements thereof, are possible.

### DETAILED DESCRIPTION

### I. OVERVIEW

Embodiments of the present technology relate to devices configured to operate on an angled surface (e.g., roofs, windows walls, and the like), and associated systems and methods. Embodiments of the present technology can be used in a wide range of applications, including, but not limited to, placing and/or removing structures (e.g., shingles or solar panels) on a surface, as well as other tasks (e.g., painting a wall, installing wallpaper, cleaning windows, etc.). Conventional methods of carrying out the aforementioned tasks are mostly manual, which can be repetitive, low-paying, and dangerous. As a result, there are labor shortages for a wide variety of construction tasks notwithstanding the demand.

Embodiments of the present technology address at least some of the above-described issues. For example, embodiments of the present technology include an apparatus comprising a body assembly, an arm assembly, and an end effector assembly. The body assembly can include a body portion, one or more wheels coupled to the body portion, one or more motors coupled to corresponding ones of the one or more wheels and configured to operate the one or more wheels to move the apparatus on the angled surface, a rail coupled to the body portion, and a plurality of cable connectors slidably coupled to the rail. Individual ones of the cable connectors can be configured to be coupled to corresponding cables. The arm assembly can have a proximal end portion coupled to the body portion of the body assembly and a distal end portion opposite the proximal end portion. The arm assembly can include a retriever at the distal end portion and having one or more retriever sensors. The end effector assembly can be releasably coupled to the retriever of the arm assembly and configured to carry a surface material.

Additionally or alternatively, embodiments of the present technology can include a system for operating a device on an angled surface. The system can comprise an apparatus, a plurality of anchor assemblies, a plurality of cables, and a controller. The apparatus can be configured to operate on the angled surface, and can include a body portion, a rail coupled to the body portion, and a plurality of cable connectors slidably coupled to the rail. The plurality of anchor assemblies can be configured to be attached to the angled surface along a periphery thereof. Each of the plurality of anchor assemblies can include a base, a drum rotatably coupled to the base, and a motor operably coupled to the drum and configured to rotate the drum relative to the base. The plurality of cables can each be wound around the drum of a corresponding one of the plurality of anchor assemblies and coupled to a corresponding one of the plurality of cable connectors. The controller can be operably coupled to the plurality of anchor assemblies, and be configured to, for each of the plurality of anchor assemblies, operate the motor such that (i) the drum rotates to wind or unwind the corresponding one of the plurality of cables and (ii) the corresponding one of the plurality of cables remains under tension and extends between the anchor assembly and the corresponding one of the cable connectors.

Embodiments of the present technology also include a method of operating an apparatus to place surface materials on an angled surface. The method can include (i) attaching a plurality of anchor assemblies along a periphery of the angled surface. Each of the plurality of anchor assemblies can include a base, a drum rotatably coupled to the base, and an anchor motor operably coupled to the drum and configured to rotate the drum relative to the base. The method can also include (ii) providing an apparatus on the angled surface. The apparatus can include a body portion, one or more wheels coupled to the body portion, one or more apparatus motors operably coupled to corresponding ones of the one or more wheels, a rail coupled to the body portion, and a plurality of cable connectors slidably coupled to the rail. The apparatus can be coupled to the plurality of anchor assemblies via a plurality of cables each extending between a corresponding one of the plurality of anchor assemblies and a corresponding one of the plurality of cable connectors. The method can additionally include (iii) operating the one or more apparatus motors to rotate the one or more wheels and thereby move the apparatus on the angled surface. The method can further include (iv) operating the anchor motor of each of the plurality of anchor assemblies to rotate the drum of the respective anchor assembly and thereby wind or unwind the corresponding one of the plurality of cables such that the plurality of cables remains under tension.

In some embodiments, an apparatus configured to operate on an angled surface relative to a direction of gravity comprises a body, an arm assembly coupled to the body, a material handling assembly coupled to the arm assembly, and a hopper coupled to the arm assembly. The body can be attached to multiple cables for positioning and/or orienting the apparatus. The arm assembly can include multiple segments and joints for moving the material handling assembly to various positions, such as between the hopper and a desired surface material placement location on the angled surface. The material handling assembly can include components for lifting surface materials and nail guns (or other attachment tools such as adhesive applicators) for attaching the surface materials onto the angled surface. The hopper can store multiple surface materials.

Additionally or alternatively, embodiments of the present technology can include a system for operating a device on an angled surface. The system can comprise an apparatus (e.g., a surface management apparatus) configured to operate over an angled surface and carry a surface material, wherein the angled surface includes an x-axis, a y-axis normal to the x-axis, and a z-axis normal to an x-y plane defined by the x-axis and the y-axis. The system can also comprise multiple anchor assemblies, each including a positioning assembly configured to position and/or orient the apparatus on the angled surface by controlling the length and tension of cables extending between the anchor assemblies and the apparatus. Operation of the apparatus and the anchor assemblies can be managed by a controller operated by an operator or autonomously.

Embodiments of the present technology also include a method of operating an apparatus and anchor assemblies to place surface materials on a surface. Embodiments of the present technology provide several advantages and improvements over existing solutions. For example, embodiments of the present technology can include a high level of automation, significantly reducing the manual labor needed, as well as reducing installation defect rates and operational expenditures associated with manual labor.

In the Figures, identical or similar reference numbers identify generally similar, and/or identical, elements. Many of the details, dimensions, and other features shown in the Figures are merely illustrative of particular embodiments of the disclosed technology. Accordingly, other embodiments can have other details, dimensions, and features without departing from the spirit or scope of the disclosure. In addition, those of ordinary skill in the art will appreciate that further embodiments of the various disclosed technologies can be practiced without several of the details described below.

### II. SYSTEMS FOR OPERATING AN APPARATUS AND ANCHOR ASSEMBLIES ON AN ANGLED SURFACE

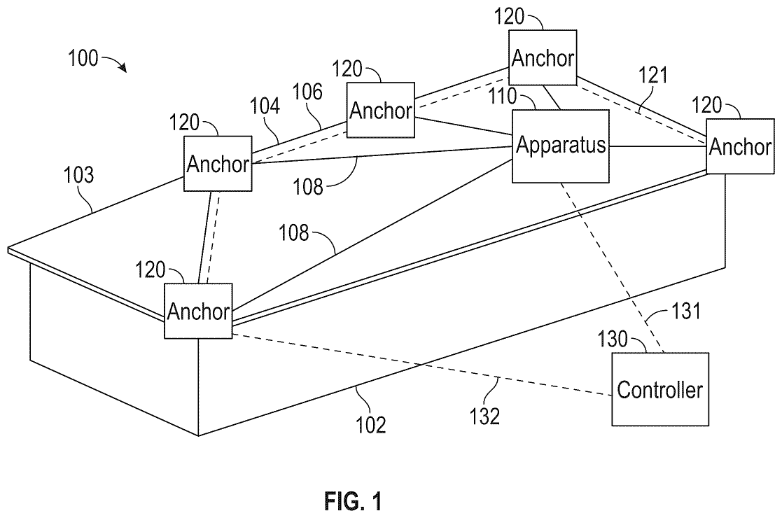

FIG. 1 is a schematic view of a system 100 for operating a device, cart, or apparatus 110 (“apparatus 110”) on an angled surface 104, configured in accordance with embodiments of the present technology. As explained herein, the angled surface 104 can be configured to have structures or surface materials (e.g., shingles) attached thereto by the apparatus 110. The system 100 can include the apparatus 110, one or more anchor assemblies 120, one or more cables 108, and a controller 130. Select components of the system 100 can be disposed on top of or otherwise proximate to a roof 103 of a building 102. The building 102 can be a residential building such as a house or an apartment, a commercial building such as an office building or a hotel, etc. The roof 103 can include one or more angled or inclined roof surfaces joined together at various angles, with the angled surface 104 being one such surface. In the illustrated embodiment, the shape of the angled surface 104 is a trapezoid. In other embodiments, the shape of the angled surface 104 can be a rectangle, a triangle, a parallelogram, or any other shape (e.g., a non-rectangular shape). The angled surface 104 can be oriented at any angle, such as vertical (i.e., parallel to a direction of gravity), horizontal (i.e., perpendicular to the vertical), at least 1 degree, 5 degrees, 10 degrees, 20 degrees, 30 degrees, 40 degrees, 50 degrees, 60 degrees, 70 degrees, 80 degrees, 85 degrees, or 89 degrees from the direction of gravity, between 5-45 degrees, or between 1-89 degrees from the direction of gravity. In some embodiments, the angled surface 104 can include an overhanging surface. As explained elsewhere herein, surface materials can include subsurface materials (i.e., materials to be applied underneath other materials on a surface, such as structural support) and materials to be applied to an underside of a surface (e.g., a ceiling).

In the illustrated embodiment, the anchor assemblies 120 are mounted on or attached to the angled surface 104. The anchor assemblies 120 can be secured manually to the roof 103 and/or the angled surface 104 in a fixed position. The number of anchor assemblies 120 can be 3, 4, 5, 6, or more. As explained elsewhere herein, the number of anchor assemblies 120 can be determined based on the degrees of freedom of the angled surface onto which the structures are being attached. For example, the number of anchor assemblies can be one, two, three, etc. more than the desired degrees of freedom.

The arrangement of the anchor assemblies 120 can also vary. For example, the anchor assemblies 120 can be positioned and secured to a periphery 106 or peripheral portions of the angled surface 104, as shown. For example, the anchor assemblies 120 can be positioned at or proximate to corners and/or edges of the angled surface 104. Additionally or alternatively, the anchor assemblies 120 can be positioned away from the periphery 106 and towards the center of the angled surface 104. In some embodiments, the anchor assemblies 120 can be positioned and secured to multiple surfaces (e.g., two or more surfaces) of the roof 103, and/or to surfaces and/or structures other than the angled surface 104, such as the other surfaces of the roof 103 and/or the building 102 in the illustrated embodiment.

Individual cables 108 can extend between individual ones of the anchor assemblies 120 and the apparatus 110. The cables 108 can comprise synthetic materials (e.g., Kevlar), metal (e.g., stainless steel), or other suitable materials, and/or be configured to withstand a maximum tension (e.g., 38 kilonewtons). In some embodiments, the lengths and/or tension of the cables 108 can be individually controlled (e.g., via mechanisms of the anchor assemblies 120 and instructions from the controller 130). As described elsewhere herein, the apparatus 110 can be positioned, oriented, and/or transported across the angled surface 104 via the anchor assemblies 120 and/or components of the apparatus 110, e.g., by controlling the length and/or tension of the individual cables 108. In some embodiments, the cables 108 can be attached to existing structures on or proximate to the angled surface 104 instead of or in addition to the anchor assemblies 120. In some embodiments, the tension in each of the cables 108 can be maintained at or below a maximum operating tension (e.g., 2 kilonewtons) during operation on the angled surface 104.

The controller 130 can be operably coupled to the apparatus 110 via a wired and/or wireless connection 131, and to at least one of the anchor assemblies 120 via a wired and/or wireless connection 132. The connections 131, 132 can be used to transfer data (e.g., operational instructions) between the apparatus 110 and the controller 130 and between the at least one of the anchor assemblies 120 and the controller 130, respectively. The connections 131, 132 can also be used to provide power to the apparatus 110 and the at least one of the anchor assemblies 120, respectively. The anchor assemblies 120 can be coupled to one another via connections 121 (e.g., in a daisy chain as shown), which can similarly transfer data and/or power between the anchor assemblies 120. The controller 130 can allow operators to control aspects of the apparatus 110, the anchor assemblies 120, and/or the overall system 100 from a remote location. The controller 130 can also be programmed to control the apparatus 110 and/or the anchor assemblies 120 in a partially or fully autonomous manner. Many embodiments of the controller 130 and/or technology described below may take the form of computer-executable instructions, including routines executed by a programmable computer. The controller 130 may, for example, include a combination of supervisory control and data acquisition (SCADA) systems, distributed control systems (DCS), programmable logic controllers (PLC), control devices, and processors configured to process computer-executable instructions. Those skilled in the relevant art will appreciate that the technology can be practiced on computer systems other than those described herein. The technology can be embodied in a special-purpose computer or data processor that is specifically programmed, configured or constructed to perform one or more of the computer-executable instructions described below. Accordingly, the terms “controller” and “computer” as generally used herein refer to any data processor. Information handled by these computers can be presented at any suitable display medium. The controller 130 can be included and/or operably coupled to any of the systems, devices, or apparatuses described herein, even if not shown or described with reference to a particular figure.

The technology can also be practiced in distributed environments, where tasks or modules are performed by remote processing devices that are linked through a communications network. In a distributed computing environment, program modules or subroutines may be located in local and remote memory storage devices. Aspects of the technology described below may be stored or distributed on computer-readable media, including magnetic or optically readable or removable computer disks, as well as distributed electronically over networks. Data structures and transmissions of data particular to aspects of the technology are also encompassed within the scope of particular embodiments of the disclosed technology.

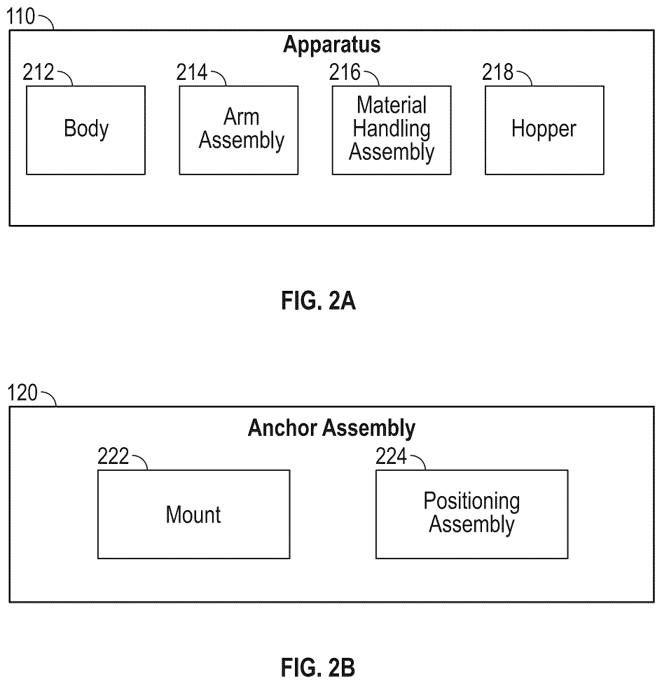

FIG. 2A is a schematic of the apparatus 110, configured in accordance with embodiments of the present technology. As shown, the apparatus 110 can include a body 212, an arm assembly 214, a material handling assembly 216, and a hopper 218. In some embodiments, the body 212 interfaces the angled surface 104 (e.g., by having wheels) and the hopper 218 stores surface materials to be handled (e.g., roof shingles). The components of the apparatus 110 can be arranged in various ways. For example, the arm assembly 214 can be coupled to the body 212, and the material handling assembly 216 and the hopper 218 can both be attached to the arm assembly 214. FIG. 2B is a schematic of one of the anchor assemblies 120, configured in accordance with embodiments of the present technology. As shown, each anchor assembly 120 can include a mount 222 and a positioning assembly 224. The mount 222 can secure each anchor assembly 120 onto the angled surface 104. The apparatus 110 and the anchor assembly 120 can include fewer, additional, and/or alternative components.

Referring to FIGS. 1-2B together, in operation, the positioning assemblies 224 of the anchor assemblies 120 can be independently operated to position, orient, and/or transport the apparatus 110 across the angled surface 104 in a desired manner. In some embodiments, the cables 108 extend between the positioning assemblies 224 and the body 212 of the apparatus 110. As the apparatus 110 moves, the arm assembly 214 can be operated to move the material handling assembly 216 between the hopper 218 and the angled surface 104. The material handling assembly 216 can be operated to retrieve one or more surface materials from the hopper 218 and can place and/or apply the one or more surface materials on, under, or proximate to the angled surface 104. For example, the surface materials can include roof shingles, the angled surface 104 can be a roof, and the apparatus 110 can remove and/or install the shingles on the roof during operation. In another example, the surface materials can include solar panels and the apparatus 110 can remove and/or install solar panels on the roof during operation. In another example, the surface materials can include underlayment and the apparatus 110 can install the underlayment underneath other materials on the angled surface 104. In another example, the surface materials can include brackets that hold down solar panels and/or shingles, and the apparatus 110 can install the brackets underneath, on the sides of, and/or over such solar panels and/or shingles. In yet another example, the surface materials can include cleaning products, the angled surface 104 can be a window, and the apparatus 110 can clean the window during operation.

As described herein, by including the positioning assembly 224 in the anchor assembly 120, the weight of the apparatus 110, which needs to be moved across the angled surface 104, can be reduced. Moreover, by including the material handling assembly 216 distinct from the body 212, the apparatus 110 can place and/or apply the surface materials at edges of the angled surface 104 without having the center of mass of the apparatus (e.g., within the body frame) at the edges of the angled surface 104, thus reducing the risk of the apparatus 110 falling over.

During operation, the position and/or orientation of the body 212 and of the material handling assembly 216 can further be arranged to optimize certain parameters, such as optimizing (e.g., reducing) tension in the cables 108, and/or optimizing (e.g., minimizing) travel distance of the apparatus 110 across the angled surface 104. The arm assembly 214 can include components that allow multiple degrees of freedom to facilitate movement of the material handling assembly 216 relative to the body 212.

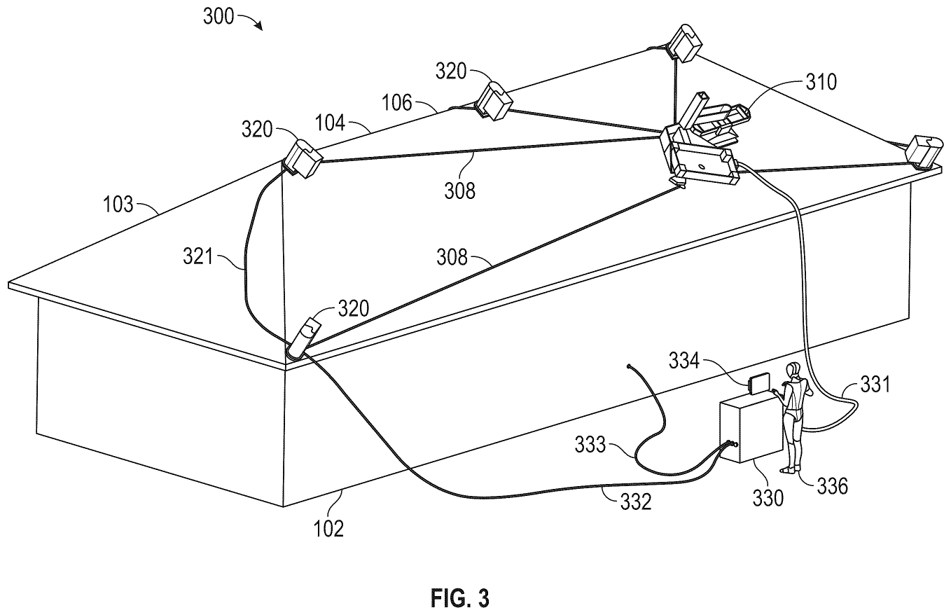

FIG. 3 is a perspective view of a system 300 (e.g., the system 100 in FIG. 1) for operating an apparatus 310 (e.g., the apparatus 110) on an angled surface 304 (e.g., the angled surface 104), configured in accordance with embodiments of the present technology. The system 300 can include the apparatus 310, one or more anchor assemblies 320 (e.g., the anchor assemblies 120), one or more cables 308 (e.g., the cables 108), and a controller 330 (e.g., the controller 130). In the illustrated embodiment, five anchor assemblies 320 are securely mounted along the periphery 106 of the angled surface 104, and are connected to one another via connections 321 (e.g., the connections 121) in a daisy chain. Moreover, the apparatus 310 is suspended on the angled surface 104 via one or more cables 308 (e.g., the cables 108) extending between the apparatus 310 and each of the anchor assemblies 320.

The controller 330 can be connected to the apparatus 310 via a utility cord 331 (e.g., the connection 131) and to at least one of the anchor assemblies 320 via another utility cord 332 (e.g., the connection 132). In some embodiments, the controller 330 receives power and/or network connectivity via cable 333, which may extend from the building 102 as shown. The controller 330 can include an interface 334 (e.g., a display) with which an operator 336 can input control instructions and/or receive data related to the system 300. While the connections between the various components of the system 300 are illustrated as wired connections, in some embodiments, the connections can be at least partially wireless. For example, the apparatus 310 and the anchor assemblies 320 can draw power from the controller 330 via the utility cords 331 and 332, respectively, while receiving and transmitting instructions and/or other data signals wirelessly.

In operation, the controller 330 can provide power and/or operation instructions from the operator 336 to the apparatus 310 via the utility cord 331 and to the anchor assemblies 320 via the utility cord 332 and the connections 321. For example, the controller 330 can be used to instruct the anchor assemblies 320 to position and/or orient the apparatus 310 on the angled surface 104 in a specific manner, and to instruct the apparatus 310 to apply one or more surface materials onto the angled surface 104 in a specific manner. In some embodiments, the utility cords 331, 332 can also provide air (e.g., compressed air) to the apparatus 310 and the anchor assemblies 320. For example, in some embodiments, a material handling assembly (e.g., the material handling assembly 216) of the apparatus 310 can be at least partially pneumatically powered.

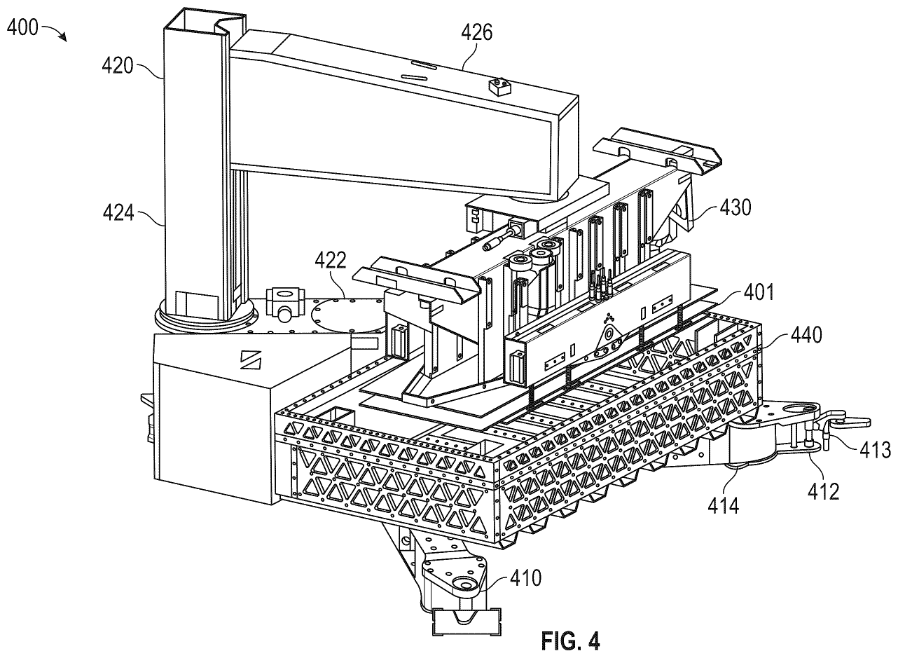

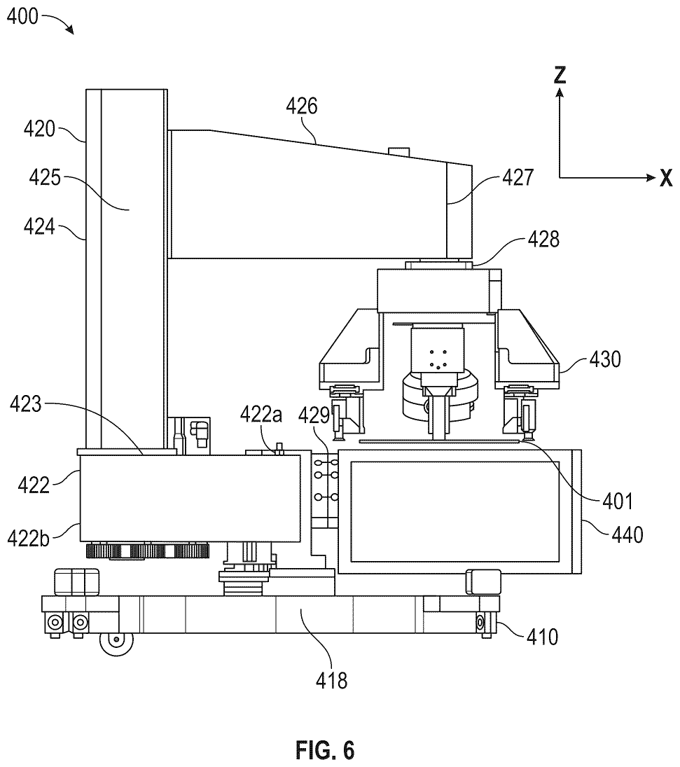

FIG. 4 is a perspective view of an apparatus 400 (e.g., the apparatus 110) that can be operated on an angled surface, configured in accordance with embodiments of the present technology. The apparatus 400 can include a body 410 (e.g., the body 212), an arm assembly 420 (e.g., the arm assembly 214), a material handling assembly 430 (e.g., the material handling assembly 216), and a hopper 440 (e.g., the hopper 218). As discussed above with reference to FIG. 2A, the components of the apparatus 400 can be arranged in various manners. For example, in the illustrated embodiment, the arm assembly 420 is rotatably coupled to the body 410 (connection shown in FIG. 6), and both the material handling assembly 430 and the hopper 440 are coupled to the arm assembly 420 (connection shown in FIG. 6).

The arm assembly 420 can include multiple arm segments, such as a first arm segment 422, a second arm segment 424 coupled to the first arm segment 422, and a third arm segment 426 coupled to the second arm segment 424. In some embodiments, the arm assembly 420 can include fewer or additional arm segments arranged in various manners. As described further herein, the multiple arm segments allow the arm assembly 420 to move with multiple degrees of freedom, which can in turn allow the material handling assembly 430 to be moved with multiple degrees of freedom and thereby moving one or more surface materials 401 in a desired manner.

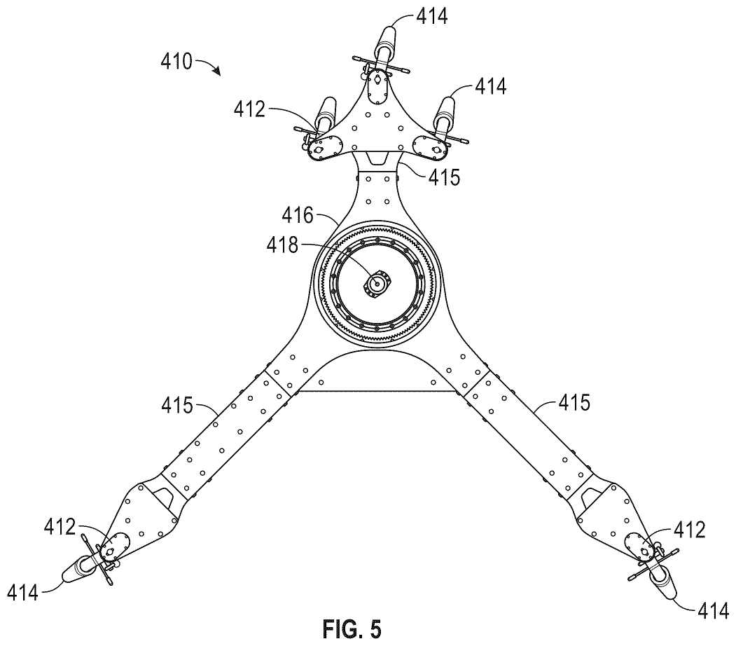

FIG. 5 is a top view of the body 410, configured in accordance with embodiments of the present technology. Referring to FIGS. 4 and 5 together, the body 410 can include a central portion 416 and a plurality of legs 415 extending radially outward from the central portion 416. A first joint 418 positioned at the central portion 416 can allow the first arm segment 422 to be rotatably coupled to the body 410. In the illustrated embodiment, the body 410 includes three legs 415, and at the end of each leg 415 are one or more cable connectors 412, one or more reflector plates 413, and one or more wheels 414. The three-legged geometry of the body 410 allows the body 410 to remain stable on the angled surface while providing sufficient space in between the legs 415 for the material handling assembly 430 to apply surface materials therebetween. As described herein, providing such space reduces the need to move the apparatus 400 in operation, thus reducing power requirements and operational complexity of the anchor assemblies. In some embodiments, the body 410 can have other shapes, such as including four legs 415, an H-shape, etc.

The cable connectors 412 can include rods, clamps, grippers, pulleys, or other structural components to which the cables can be coupled. In the illustrated embodiment, the body 410 includes five cable connectors 412, each corresponding to one of the five anchor assemblies 320 illustrated in FIG. 3. Each reflector plate 413 can provide a surface onto which a laser or other waveform emitted from a distance sensor included in each anchor assembly (described further herein) can be reflected. The wheels 414 can allow the body 410, and thus the entire apparatus 400, to move smoothly and easily across the angled surface.

FIG. 6 is a side view of the apparatus 400, configured in accordance with embodiments of the present technology. In the illustrated embodiment, the first arm segment 422 includes a vertical portion 422a rotatably coupled to the body 410 via the first joint 418 and a horizontal portion 422b extending radially outward from the vertical portion 422a. Moreover, the second arm segment 424 is rotatably coupled to the horizontal portion 422b via a second joint 423, the third arm segment 426 is linearly coupled to the second arm segment 424 via a third joint 425, and the material handling assembly 430 is rotatably and/or linearly coupled to the third arm segment 426 via a fourth joint 427. For example, the first joint 418 can allow rotation of the first arm segment 422 (e.g., the vertical portion 422a) about the z-axis, the second joint can allow rotation of the second arm segment 424 about the z-axis, the third joint 425 can allow linear movement of the third arm segment 426 along the z-axis, and the fourth joint 427 can allow rotation and/or linear movement of the material handling assembly 430 about and/or along the z-axis.

In some embodiments, the material handling assembly 430 can be releasably coupled to the arm assembly 420 (e.g., at the fourth joint 427) via a first coupling mechanism 428 (e.g., a release latch), and the hopper 440 can be releasably coupled to the arm assembly 420 (e.g., to the first arm segment 422) via a second coupling mechanism 429 (e.g., a release latch). The first and second coupling mechanisms 428, 429 can allow the material handling assembly 430 and the hopper 440 (and/or portions thereof) to be quickly and easily swapped for another, providing a degree of modularity for the apparatus 400. For example, if the hopper 440 runs out of surface materials 401, the empty hopper 440 can easily be swapped for a hopper pre-filled with surface materials 401. The first and second coupling mechanisms 428, 429 can also allow the material handling assembly 430 and the hopper 440 (or portions thereof) to be quickly and easily replaced with other assemblies or components, such as those that apply or install different surface materials, or operate differently. In some embodiments, the dimensions of the components of the arm assembly 420 can be set such that the material handling assembly 430 can be aligned with the hopper 440 to retrieve surface materials 401 therefrom.

In operation, each of the first through fourth joints 418, 423, 425, 427 can be motorized and independently controlled to move the material handling assembly 430 and/or the hopper 440 to desired positions and orientations. For example, the first joint 418 can be actuated such that the hopper 440 is positioned away from a desired surface material placement location on the angled surface, the second joint 423 can be actuated to align the material handling assembly 430 with the hopper 440 or the desired surface material placement location, and the third joint 425 and/or the fourth joint 427 can be actuated for better alignment and to allow the material handling assembly 430 to pick up or place the surface material 401.

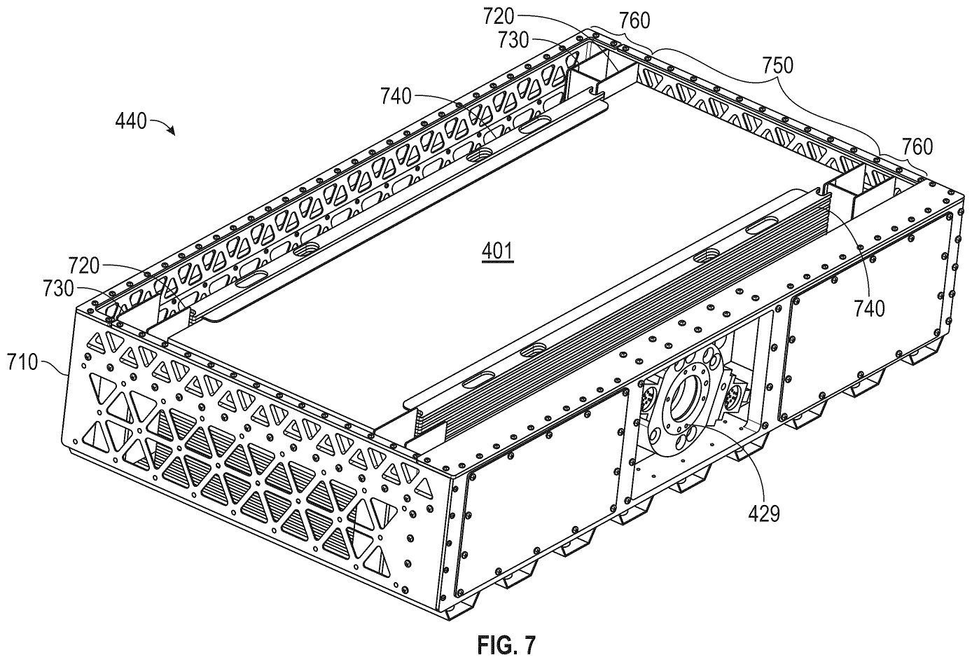

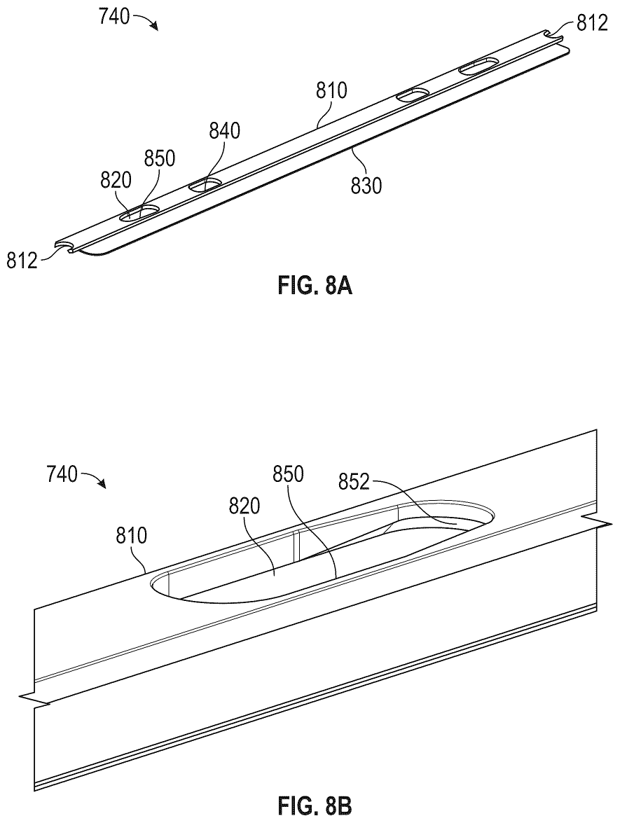

FIG. 7 is a perspective view of the hopper 440, configured in accordance with embodiments of the present technology. The hopper 440 can include a hopper frame 710, a first set of fixtures 720 positioned within the hopper frame 710, and a second set of fixtures 730 positioned within the hopper frame 710. A sidewall of the hopper frame 710 can include a portion of the coupling mechanism 429. The hopper frame 710 can have a central zone 750 in which the surface materials 401 are stored, and two side zones 760 on either side of the central zone 750. Furthermore, in the illustrated embodiment, the surface materials 401 are stacked with spacers 740 positioned on the sides of and in between individual ones of the surface materials 401. As described further herein, the spacers 740 can separate adjacent surface materials 401 from one another to prevent sticking, and can allow the material handling assembly 430 to lift individual ones of the surface materials 401 with relative ease. When the spacers 740 are positioned in the central zone 750 and between individual ones of the surface materials 401 on either side, as illustrated, the spacers 740 can be held in place within the hopper frame 710 by the first set of fixtures 720. For example, as better shown in FIG. 8A, the spacers 740 can include grooves that fit around the edges of the first set of fixtures 720.

As described further herein, to place the surface materials 401 onto the angled surface, the material handling assembly 430 can lift an individual surface material 401 from the hopper 440 by lifting the two spacers 740 positioned on either side of the individual surface material 401, and transfer the surface material 401 to the desired surface material placement location. Once the individual surface material 401 is applied thereon, the material handling assembly 430 can return the two used spacers 740 back to the hopper 440 and place them in the side zones 760. More specifically, the two used spacers 740 can be secured by having the grooves of the spacers 740 fit around the edges of the second set of fixtures 730. One of ordinary skill in the art will appreciate that the hopper 440 can have other designs to facilitate storage of the surface materials 401 and the spacers 740.

FIGS. 8A and 8B are perspective and enlarged perspective views of the spacer 740, configured in accordance with embodiments of the present technology. Referring first to FIG. 8A, the spacer 740 can include a backbone 810, a sheet 820 extending underneath and outward of the backbone 810, and a cover 830 applied over the portion of the sheet 820 extending outward of the backbone 810. The backbone 810 and the sheet 820 can be made from metal, plastic, or other suitable material. The backbone 810 can include grooves 812 on either end, one or more first apertures 840, and one or more second apertures 850. The grooves 812 can fit around the first set of fixtures 720 and the second set of fixtures 730 illustrated in and described above with reference to FIG. 7.

The portion of the sheet 820 extending outward of the backbone 810 can be positioned in between individual ones of the surface materials 401, and can remain rigid during operation such that lifting a pair of the spacers 740 lifts the surface material 401 placed on top of the portion of the sheet 820 extending outward of the backbone 810. The cover 830 can be made from a non-sticking material (e.g., Teflon) to reduce sticking of the spacer 740 to the surface material 401 and between the surface materials 401. For example, when stored in the hopper 440, the surface materials 401 may be coated with an adhesive conducive to applying the surface materials 401 onto the angled surface.

In the illustrated embodiment, the sheet 820 includes apertures corresponding to and aligned with the first apertures 840, but remains continuous underneath the second apertures 850. As described further herein, during operation, the first apertures 840 can allow a component or sensor of the material handling assembly 430 to fully pass through the spacer 740 and reach the angled surface to sense the relative position of the angled surface. On the other hand, the second apertures 850 can be used to allow the material handling assembly 430 to lift the spacer 740, and thus the surface material 401. For example, as shown in FIG. 8B, the second apertures 850 can include a grooved portion 852 that a corresponding knob (discussed further herein) of the material handling assembly 430 can be inserted at least partially into and lift the spacer 740.

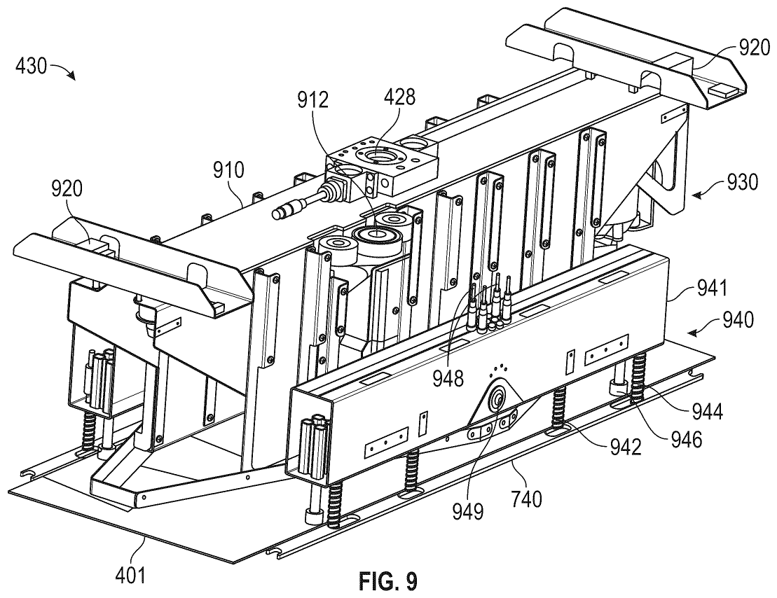

FIG. 9 is a perspective view of the material handling assembly 430, configured in accordance with embodiments of the present technology. The material handling assembly 430 can include a frame 910, one or more sensors 920 coupled to the frame 910, a nail gun assembly 930 coupled to the frame 910, and two gripper assemblies 940 coupled to the frame 910. In the illustrated embodiment, the coupling mechanism 428 is coupled to an upper portion of the frame 910 and a motor 912 for operating the nail gun assembly 930 is coupled to a side portion of the frame 910. In some embodiments, the motor 912 operates the nail gun assembly 930 via a belt drive. In some embodiments, the sensors 920 can be attached to the upper portion of the frame 910 and arranged to face downward (e.g., toward the angled surface). The sensors 920 can be imaging sensors (e.g., cameras, machine vision cameras), distance sensors (e.g., lasers), or other types of sensors.

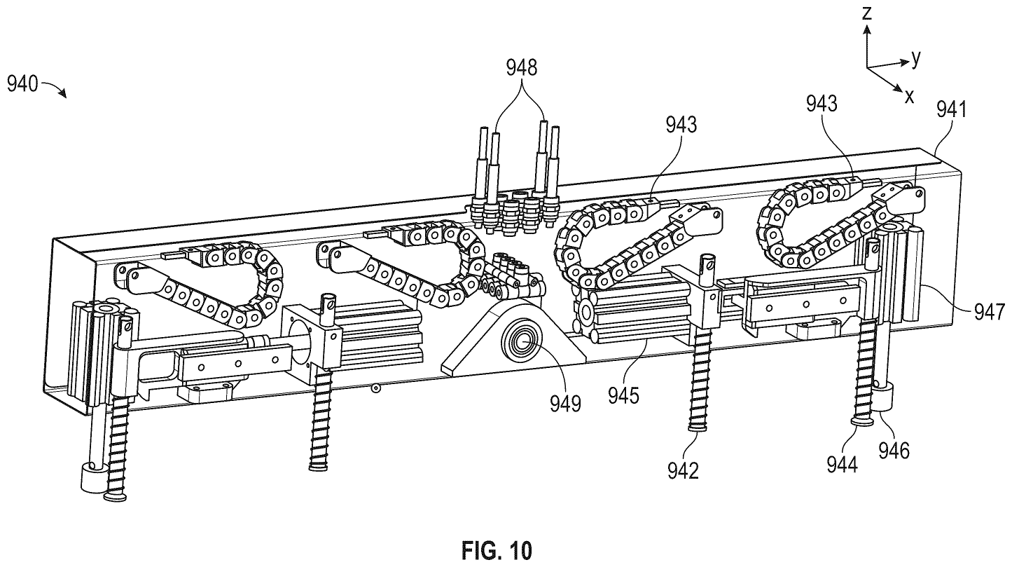

FIG. 10 is a perspective view of the gripper assembly 940 with a portion of the frame 941 of the gripper assembly 940 rendered at least partially transparent for illustrative purposes. Referring to FIGS. 9 and 10 together, each gripper assembly 940 can include the frame 941, surface detectors 942, grippers 944, stompers 946, electrical and/or pneumatic connectors 948, and a pivot 949. The surface detectors 942, the grippers 944, and the stompers 946 can extend from within the frame 941 and out downward to engage the spacer 740 and/or the surface material 401, as shown in FIG. 9. The gripper assembly 940 can also include wire guides 943 for each of the surface detectors 942 and the grippers 944, horizontal actuators 945 for the grippers 944, and vertical actuators 947 for the stompers 946. The wire guides 943, the horizontal actuators 945, and the vertical actuators 947 can be housed within the frame 941, as shown. The horizontal actuators 945 and the vertical actuators 947 can be operated electrically and/or pneumatically using electricity and/or compressed air received from the connectors 948, which can be coupled to the utility cord 331 (FIG. 3). The pivot 949 can allow the gripper assembly 940 to align with the surface material and/or the angled surface 104, for example, if the arm assembly 420 is misaligned.

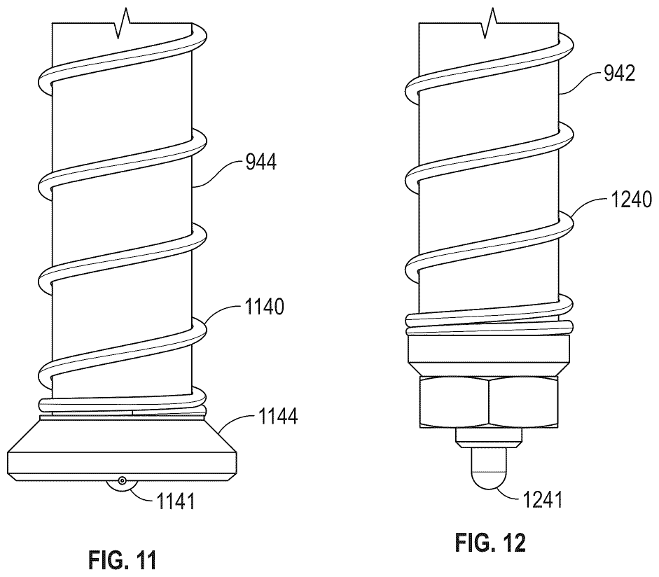

FIG. 11 is an enlarged side view of the gripper 944. The gripper 944 can include a chamfered edge 1144 shaped to engage the grooved portion 852 in the second aperture 850 of the spacer 740 (FIG. 8B). A biasing member 1140 (e.g., a compressible spring) can be positioned to bias the gripper 944 downward. The gripper 944 can also include a sensor (e.g., a limit switch) 1141 positioned at a lower portion of the gripper 944.

FIG. 12 is an enlarged side view of the surface detector 942. A biasing member 1240 (e.g., a compressible spring) can be positioned to bias the surface detector 942 downward. The surface detector 942 can include a sensor 1241 (e.g., a limit switch) positioned at a lower portion of the surface detector 942.

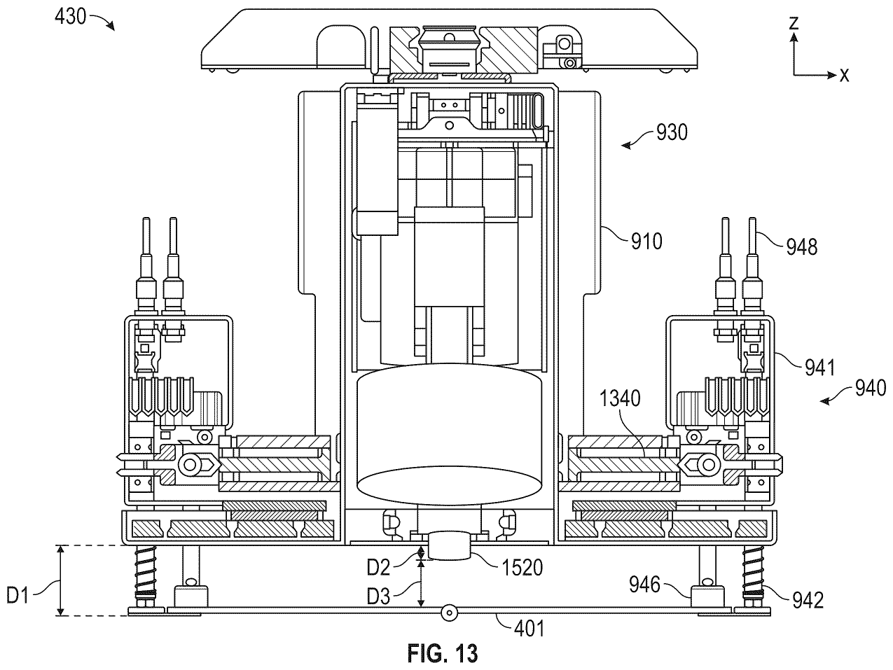

FIG. 13 is a partially cross-sectional view of the material handling assembly 430. In particular, cross-sections of the connection between the frame 910 of the material handling assembly 430 and the gripper assemblies 940 are shown. The material handling assembly 430 can include actuators 1340 (e.g., linear actuators) extending between the frame 910 and each of the gripper assemblies 940. The actuators 1340 can be operated electrically and/or pneumatically.

Referring to FIGS. 9-13 together, in operation, once the material handing assembly 430 is aligned with the hopper 440 by operating the arm assembly 420 (e.g., as shown in FIG. 6), the material handling assembly 430 can be lowered (e.g., by operating the third joint 425) until the sensor 1141 detects that the gripper 944 has reached the sheets 820 of the two spacers 740. The grippers 944 can be biased downward by the biasing member 1140, and can move a total distance of D1 (FIG. 13). In some embodiments, D1 can be about 30 mm, 35 mm, 40 mm, 45 mm, 50 mm, or 30-50 mm (e.g., 38 mm). The horizontal actuators 945 can then move the grippers 944 horizontally (e.g., along the y-axis shown in FIG. 10) until the chamfered edge 1144 engages the grooved portion 852 in the second aperture 850 of the spacer 740. The material handling assembly 430 can then be lifted (e.g., by operating the third joint 425), which in turn lifts the two spacers 740 by virtue of the engagement between the chamfered edge 1144 engages the grooved portion 852, and also lifts the surface material 401 supported on the covers 830 of the two spacers 740. In some embodiments, the vertical actuator 947 operates the stompers 946 to push the surface material 401 against the covers 830 of the spacers 740, thereby securing the surface material 401 to the spacers 740 during operation.

Once the arm assembly 420 moves the material handling assembly 430 to the desired surface material placement location on the angled surface, the material handling assembly 430 can be lowered until the sensor 1241 detects that the surface detectors 942, which extend through the first apertures 840 of the spacers 740 (FIG. 8A), have reached the angled surface. The surface detectors 942 can be biased downward by the biasing member 1240, and can move a total distance of D1. Once the surface material 401 is applied onto the angled surface (e.g., via the nail gun assembly 930), the actuators 1340 can move the two spacers 740 horizontally outward (e.g., along the x-axis shown in FIG. 13). As discussed herein, the covers 830 of the spacers 740 can be made from an anti-sticking material, allowing the spacers 740 to disengage from the surface material 401. The arm assembly 420 can then move the material handling assembly 430 back to the hopper 440. More specifically, once the spacers 740 are aligned with the side zones 760 of the hopper 440 (FIG. 7), the horizontal actuators 945 can move the grippers 944 until the chamfered edge 1144 engages the grooved portion 852, allowing the spacers 740 to be dropped into the side zones 760 of the hopper 440.

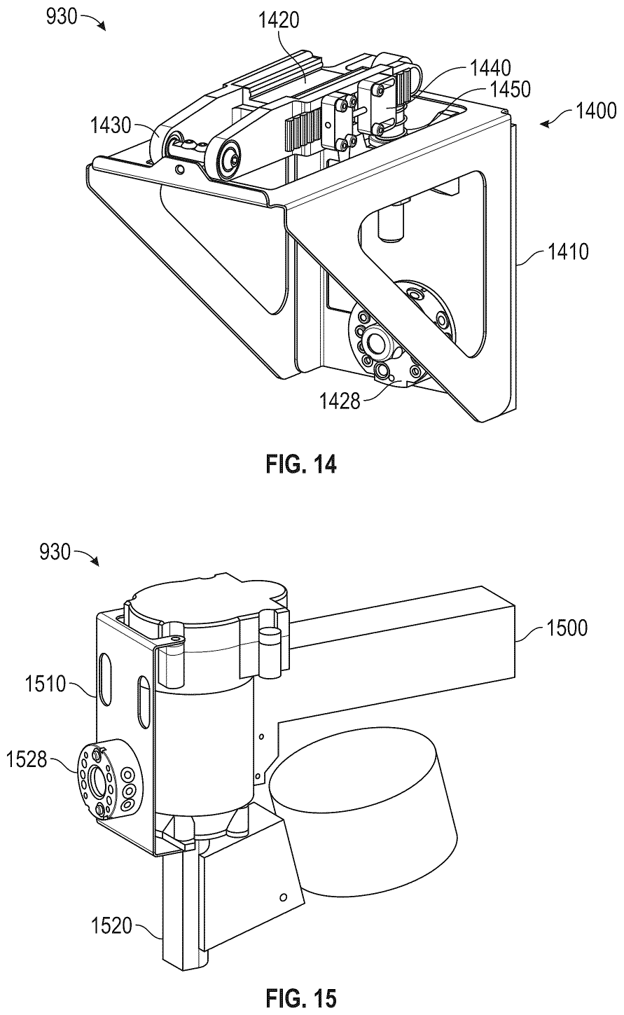

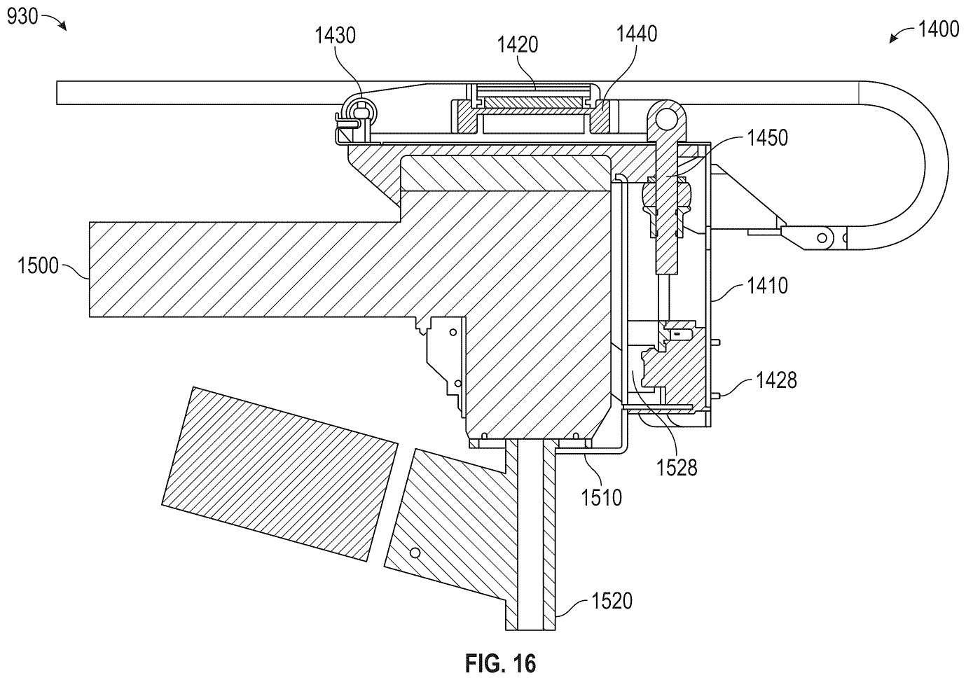

FIGS. 14 and 15 are perspective views of components of the nail gun assembly 930. More specifically, FIG. 14 illustrates a nail gun actuation subassembly 1400 and FIG. 15 illustrates a nail gun 1500. FIG. 16 is a cross-sectional view of the nail gun assembly 930 in an assembled state. Referring first to FIG. 14, the nail gun actuation subassembly 1400 includes a frame 1410 coupled to the frame 910 of the material handling assembly 430, a linear bearing 1420 coupled to the frame 1410 via pivot 1430, and a belt coupling and tensioning subassembly 1440 coupled to the linear bearing 1420, and a biasing member 1450 (e.g., a spring) coupled to the linear bearing 1420. The frame 1410 can include a main coupling mechanism 1428. Referring next to FIG. 15, the nail gun 1500 can be attached to a bracket 1510 and a secondary coupling mechanism 1528 can be attached to the bracket 1510. The nail gun 1500 can include a nail outlet 1520 through which the nail gun 1500 can eject nails.

When the nail gun assembly 930 is assembled, as shown in FIG. 16, the secondary coupling mechanism 1528 can engage the main coupling mechanism 1428, which can in turn engage the coupling mechanism 428 (FIG. 6). Having the secondary coupling mechanism 1528 distinct from the main coupling mechanism 1428 enables a higher degree of modularity, as the second coupling mechanism 1528 allows the nail gun 1500 to be replaced (e.g., when the nail gun 1500 has run out of nails, when the nail gun 1500 is in need of repair) without having to replace the entire nail gun assembly 930. Yet, the main coupling mechanism 1428 still allows the entire nail gun assembly 930 to be replaced if necessary.

As discussed herein, in some embodiments, the motor 912 (FIG. 9) can use a drive belt to operate the nail gun 1500 to eject nails out through the outlet 1520 for applying surface materials 401 onto the angled surface. The belt coupling and tensioning subassembly 1440 can manage the positioning of and the tension in the drive belt (not shown) extending to the nail gun 1500 from the motor 912. The biasing member 1450 can be biased (e.g., a pre-loaded spring) to push the linear bearing 1420 downward relative to the pivot 1430. The biasing member 1450 can thereby keep the nail gun assembly 930 intact (e.g., maintain contact between the components) notwithstanding any recoil force from the nail gun 1500. Returning to FIG. 13, the material handling assembly 430 can allow for the nail gun 1500 to move a total distance of D2 in the case of nail gun overdrive and/or recoil. The material handling assembly 430 can also allow for the nail gun 1500 to move a total distance of D3 before the nail gun 1500 contacts the surface material 401 held by the grippers 944. In some embodiments, each of D2 and D3 can be about 10 mm, 15 mm, 20 mm, 25 mm, 30 mm, or 10-30 mm (e.g., 19 mm).

One of ordinary skill in the art will appreciate that the nail gun assembly 930 can have other configurations for applying nails onto surface materials at the angled surface. Furthermore, one of ordinary skill in the art will also appreciate that the nail gun assembly 930 can be replaced with other assemblies for attaching surface materials onto the angled surface, such as an adhesive applicator. Additional details regarding apparatuses configured to operate on an angled surface and, in particular, material handling assemblies are provided in U.S. Pat. No. 12,158,004, titled “DEVICES CONFIGURED TO OPERATE ON AN ANGLED SURFACE, AND ASSOCIATED SYSTEMS AND METHODS,” and filed on Jul. 12, 2023, the disclosure of which is incorporated by reference herein in its entirety.

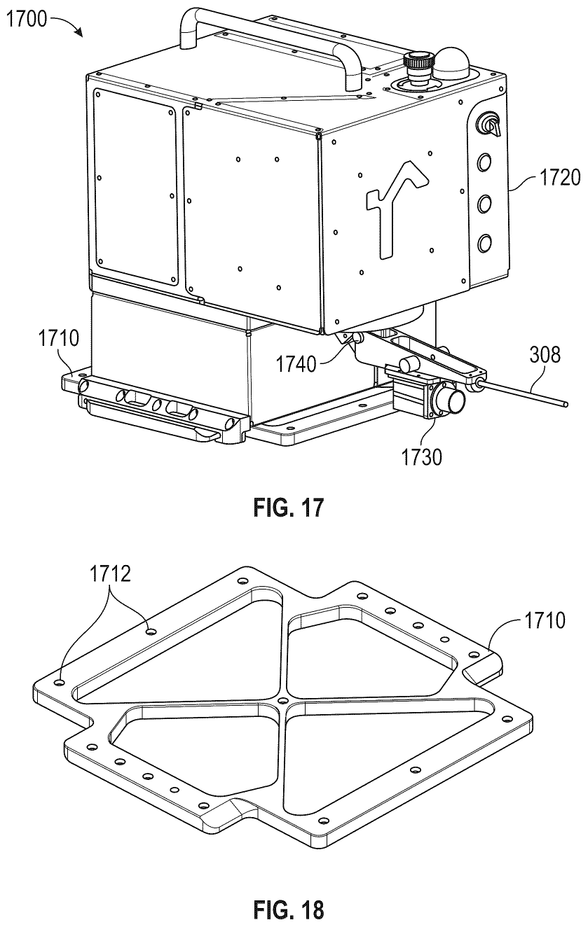

FIG. 17 is a perspective view of an anchor assembly 1700 (e.g., the anchor assembly 120), configured in accordance with embodiments of the present technology. The anchor assembly 1700 can include a base plate 1710, a housing 1720 coupled to the base plate 1710, a distance sensor 1730 coupled to and facing away from the housing 1720, and a hinge or pivot 1740 coupling the distance sensor 1730 to the housing 1720. As discussed further herein, the cable 308 can extend out from within the housing 1720. The pivot 1740 can allow the cable 308 to extend at various angles between the anchor assembly 1700 and the apparatus.

FIG. 18 is a perspective view of the base plate 1710. The base plate 1710 can include openings 1712 for receiving fasteners (e.g., bolts) or other coupling tools, and the housing 1720 can be securely attached to the angled surface via such fasteners. The base plate 1710 can include struts for a lightweight structure while having a wide attachment area. In the illustrated embodiment, the base plate 1710 is generally flat, making the anchor assembly 1700 suitable for attaching to flat portions of the angled surface or other surfaces. In some embodiments, the base plate 1710 can include a curvature to make the anchor assembly 1700 suitable for attaching to curved portions of the angled surface or other surfaces (e.g., a dome-shaped roof).

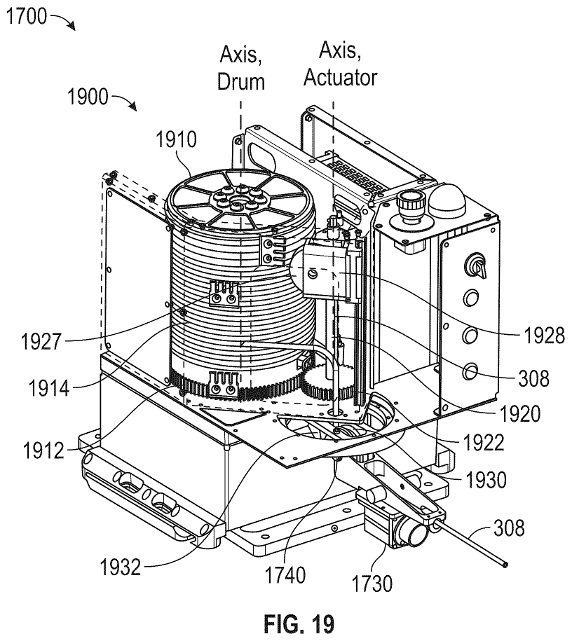

FIG. 19 is a perspective view of the anchor assembly 1700 with the housing 1720 rendered at least partially transparent for illustrative purposes. As shown, the anchor assembly 1700 includes a positioning assembly 1900 inside the housing 1720. The positioning assembly 1900 can include a cable drum 1910 disposed along a drum axis (“axis, drum”) substantially oriented vertically, an actuator 1920 (e.g., a lead screw) disposed along an actuator axis (“axis, actuator) and operably coupled to the cable drum 1910, and a drum tensioner or drum winder 1928 (“drum winder 1928”) coupled to the actuator 1920. In some embodiments, the drum axis and the actuator axis are parallel to one another. The cable drum 1910 can be coupled to a first gear 1912, the actuator 1920 can be coupled to a second gear 1922, and the first and second gears 1912, 1922 can be engaged such that rotation of one rotates the other. The cable drum 1910 can include a spiraling groove 1914 on the outer surface for receiving one of the cables 308.

The drum winder 1928 can include a pulley 1927 for engaging the cable 308, which can extend from the pulley 1927 to another pulley 1930 mounted on the pivot 1740. A force-measuring sensor 1932 (e.g., a load cell, a force transducer) can be disposed proximate to the pulley 1930. The cable 308 can continue to extend from the pulley 1930 toward the cable connectors 412 on the body 410 of the apparatus 400 (FIGS. 4 and 5).

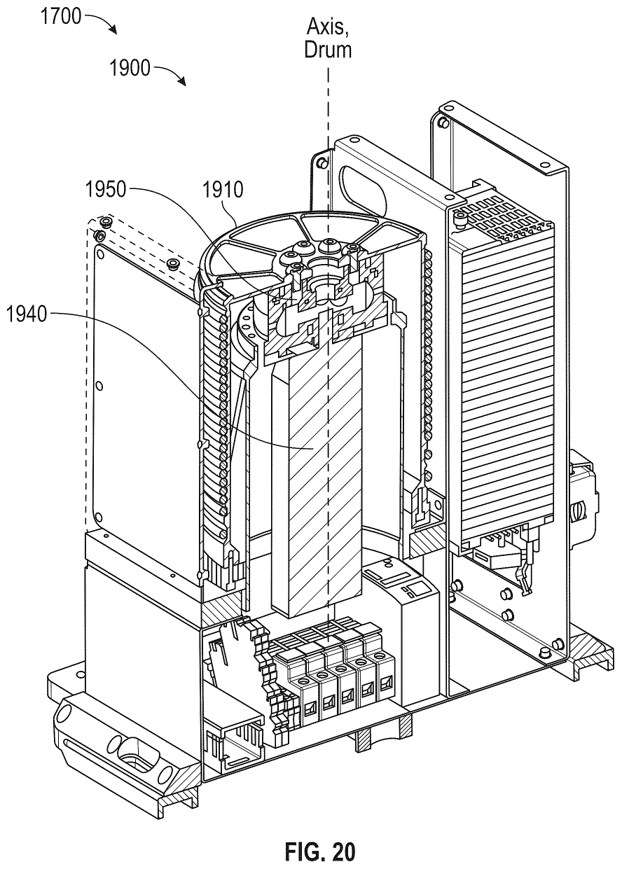

FIG. 20 is a cross-sectional view of the anchor assembly 1700. As shown, the positioning assembly 1900 further includes a motor 1940 and a gearbox 1950 disposed inside of the cable drum 1910. The motor 1940 can be powered and controlled via the utility cord 332 and the connections 321 (FIG. 3). The gearbox 1950 can provide a desired gear ratio between rotation of the motor 1940 and rotation of the cable drum 1910. Including the motor 1940 and the gearbox 1950 inside of the cable drum 1910 can provide significant space savings compared to, for example, including the motor 1940 and the gearbox 1950 outside of the cable drum 1910 and within the housing 1720.

During operation of the positioning assembly 1900, the motor 421 can be controlled (e.g., via the controller 330 in FIG. 3) to rotate the cable drum 1910 about the drum axis based on a desired tension, and at desired rotation rates and/or angles. Rotation of the cable drum 1910 rotates the first gear 1912, thereby rotating the second gear 1922 and the actuator 1920. The actuator 1920 moves the drum winder 1928 along the actuator axis. The drum winder 1928 can ensure that the cable 308 remains in the spiraling groove 1914 during rotation of the cable drum 1910, reducing the risk of the cable 308 tangling or causing an uneven rate of winding or unwinding. The gear ratio between first and second gears 1912, 1922 can be configured such that the actuator 1920 moves the drum winder 1928 at the same or similar rate as the portion of the cable 308 being wound onto or unwound from the spiraling groove 1914.

Winding or unwinding a particular cable 308 via the corresponding motor 1940 changes the length of the portion of the cable 308 extending between the corresponding anchor assembly 1700 and the apparatus (e.g., the apparatus 400). Therefore, the motor 1940 can be controlled to shorten the cable 308 to position the apparatus closer to the corresponding anchor assembly 1700, or lengthen the cable 308 to position the apparatus farther from the corresponding anchor assembly 1700.

As tension in the cable 308 changes during operation of the positioning assembly 1900, the cable 308 can push against the pulley 1930, and because the pulley 1930 may only be attached to the housing 1720 via the pivot 1740, the pulley 1930 can then push against the force-measuring sensor 1932. The force-measuring sensor 1932 can be used to calculate real-time tension in the cable 308, which can then be used to control movement of the apparatus. Moreover, the distance sensor 1730 can measure the distance between the corresponding anchor assembly 1700 and the apparatus in real-time. For example, the distance sensor 1730 can comprise a laser distance sensor that can emit a laser onto the corresponding reflector plate 413 (FIG. 4) of the apparatus. The measured tension and distance (e.g., length) of the cable 308 for each anchor assembly 1700 can be communicated back to the controller (e.g., the controller 330) and be used to position and/or orient the apparatus in a desired manner and in real-time.

Including the positioning assemblies 1900 in the anchor assemblies 1700 as opposed to, for example, on the apparatus 400, can provide significantly a reduced weight of the apparatus 400, reduced complexity, and reduced power consumption. This can be at least partly because the apparatus 400 is moved and rotated on the angled surface 104 multiple times during operation, whereas the anchor assemblies 1700 do not. Moreover, off-loading components (e.g., the positioning assemblies 1900) from the apparatus 400 and onto the anchor assemblies 1700 can increase the degree of modularity, increase the level of customization and potential scaled production, etc. For example, if more cables and corresponding anchor assemblies 1700 are required, the apparatus 400 merely needs to have additional cable connectors instead of additional positioning assemblies 1900. In some embodiments, the apparatus 400 can benefit from a weight savings of approximately 100-200 lbs. by including the positioning assemblies 1900 in the anchor assemblies 1700.

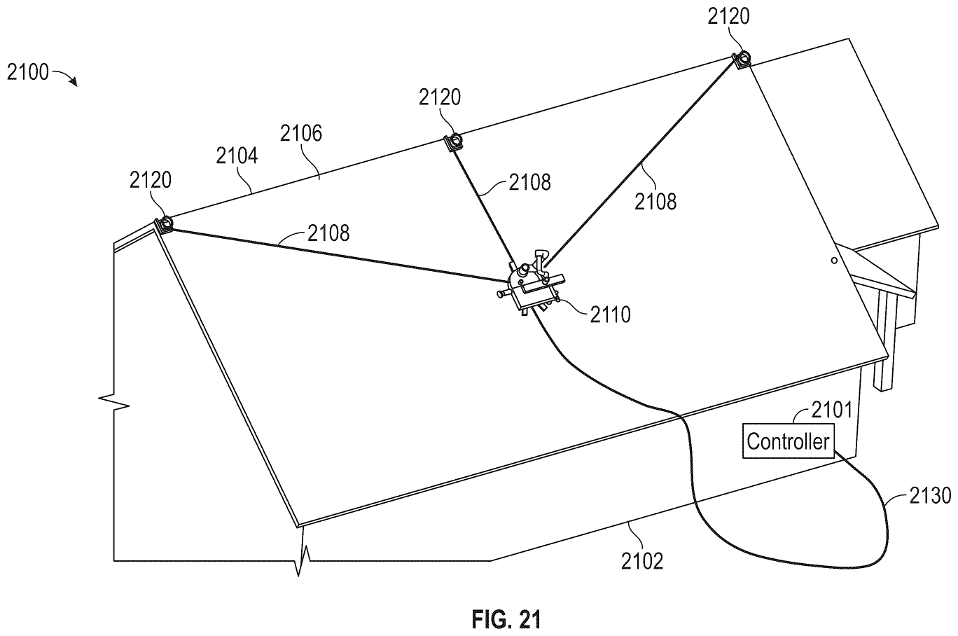

FIG. 21 is a perspective view of a system 2100 operating on an angled surface 2106 and configured in accordance with embodiments of the present technology. The system 2100 can include an apparatus 2110, a plurality of cables 2108, and a plurality of anchor assemblies 2120 positioned on the angled surface 2106. In the illustrated embodiment, the angled surface 2106 is a slanted roof 2104 of a building 2102 (e.g., a residential building, a commercial building, and/or the like). It is appreciated that the system 2100 can operate on other types of angled surfaces.

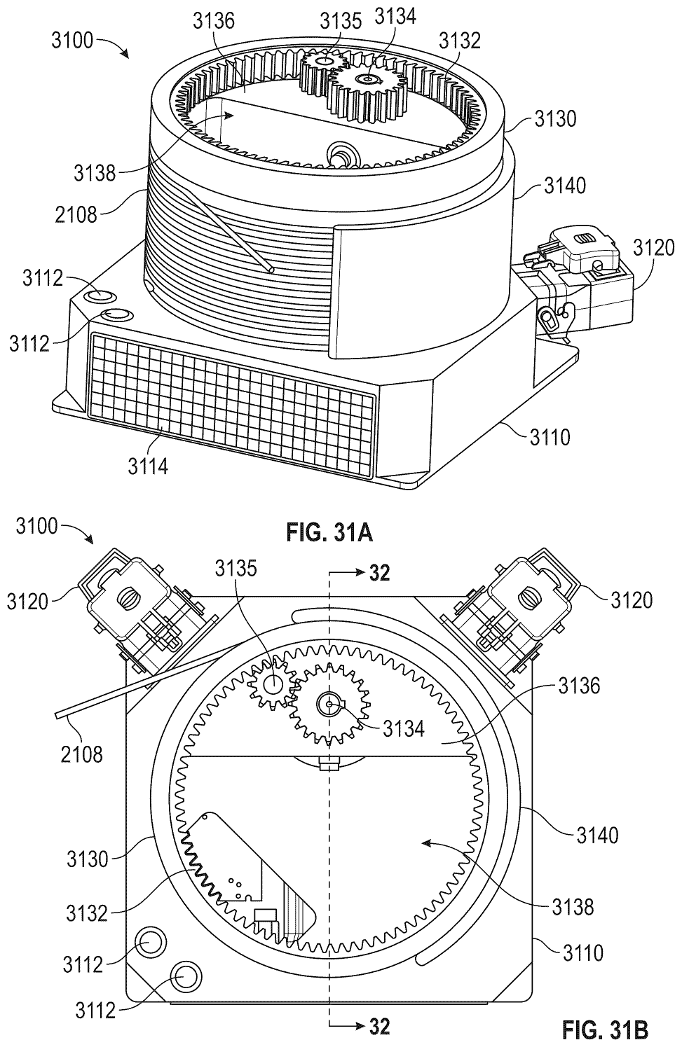

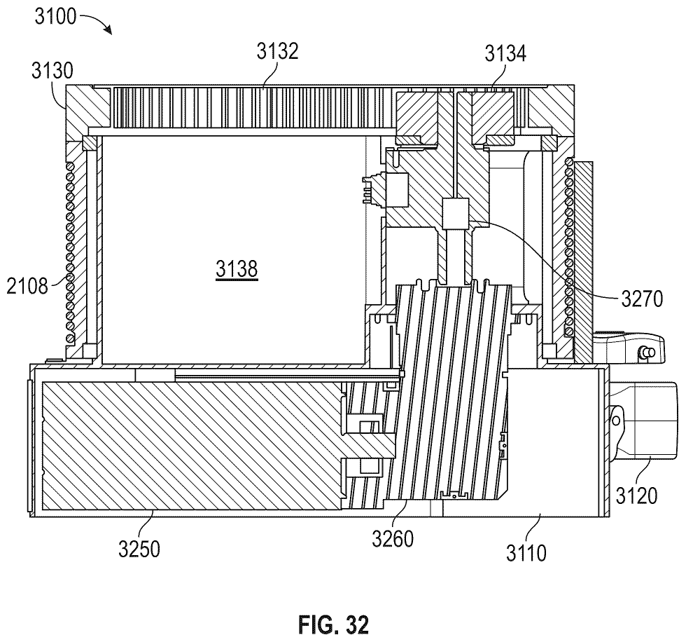

The plurality of anchor assemblies 2120 can be mounted along a periphery of the angled surface 2106. For example, as shown in FIG. 21, a first anchor assembly 2120 is mounted to a top-left corner of the roof 2104, a second anchor assembly 2120 is mounted to a top-right corner of the roof 2104, and a third anchor assembly 2120 is mounted to a top edge of the roof 2104 between (e.g., halfway between) the first and second anchor assemblies 2120. It is appreciated that in other embodiments, the anchor assemblies 2120 can be mounted elsewhere on the angled surface 2106 and/or the system 2100 can include a different number of anchor assembles 2120. In some embodiments, the anchor assemblies 2120 can be operably coupled to one another via, e.g., power and signal cables (not shown) that form a daisy chain with the anchor assemblies 2120. In such embodiments, a power and signal cable extending from one of the anchor assemblies 2120 can be operably coupled to a power source and/or controller (not shown). The anchor assembly 1700 illustrated in and described above with reference to FIGS. 17-20 can be an example of the anchor assemblies 2120. Another example configuration of the anchor assemblies 2120 is illustrated in and described below with reference to FIGS. 31A-32.

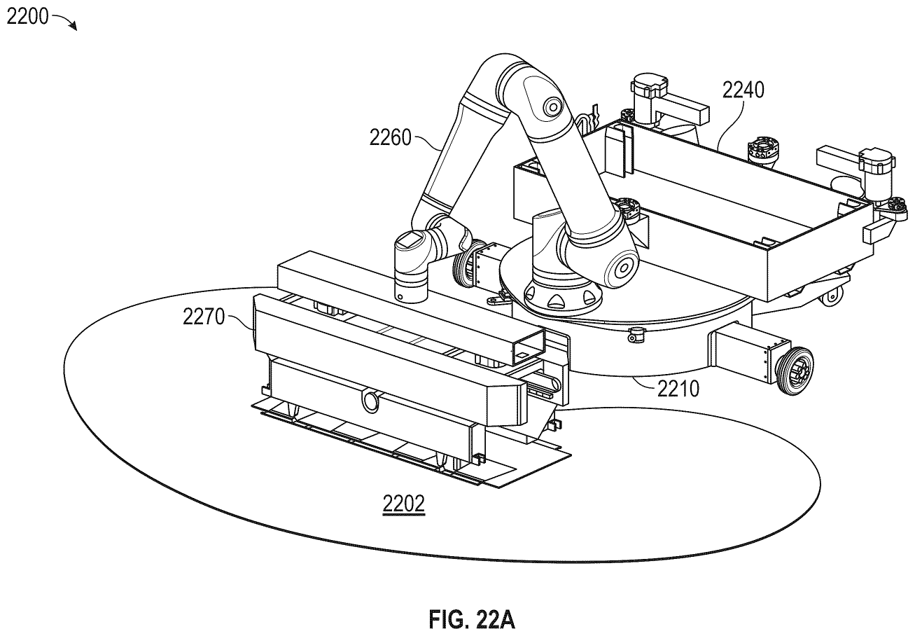

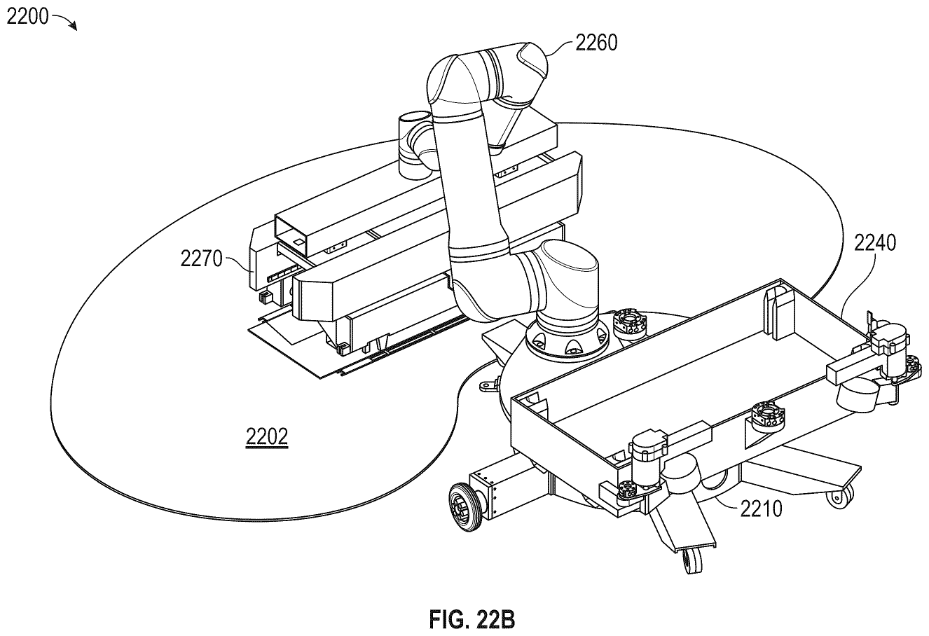

The apparatus 2110 can include movable and/or actuatable components for moving across the angled surface 2106 and/or placing materials (e.g., roof shingles) onto the angled surface 2106. For example, the apparatus 2110 can include motorized and/or passive (e.g., caster) wheels interfacing the angled surface 2106. An example configuration of the apparatus 2110 is illustrated in and described below with reference to FIGS. 22A-30. Also, as shown, the apparatus 2110 can be coupled to each of the anchor assemblies 2120 via a corresponding one of the cables 2108. Thus, the cables 2108 and friction between the wheels of the apparatus 2110 and the angled surface 2106 can at least partially counterbalance the weight of the apparatus 2110 and keep the apparatus 2110 on the angled surface 2106. The system 2100 can also include a controller 2101 (shown schematically) and a power and signal cable 2130 extending between the apparatus 2110 and the controller 2101. The controller 2101 can be located inside or external to the building 2102, and can be operably coupled to an external power source (not shown).

In operation, each of the anchor assemblies 2120 and/or wheels on the apparatus 2110 can be controlled (e.g., via the controller 2101) to move the apparatus 2110 to a desired position and/or orientation on the angled surface 2106. For example, each of the anchor assemblies 2120 can include a positioning assembly (e.g., a winch assembly) and/or the wheels on the apparatus 2110 can be motorized. Furthermore, various components of the apparatus 2110 (e.g., an arm assembly, an end effector assembly) can be controlled to place surface materials (e.g., roof shingles) onto the angled surface 2106, perform cleaning, maintenance, inspection, and/or the like of the angled surface 2106, etc. The power and signal cable 2130 and one or more other power and signal cables (not shown) operably coupled to the anchor assemblies 2120 can deliver power and/or control signals accordingly. Therefore, the system 2100 as a whole can be operated to perform one or more activities on the angled surface 2106 without, e.g., a human operator on the angled surface 2106.

FIGS. 22A and 22B are front perspective and rear perspective views, respectively, of an apparatus 2200 that can be operated on an angled surface, configured in accordance with embodiments of the present technology. The apparatus 2200 can be an example of the apparatus 2110 of the system 2100 illustrated in FIG. 21. Referring to FIGS. 22A and 22B together, the apparatus 2200 can include a body assembly 2210, a hopper assembly 2240, an arm assembly 2260, and an end effector assembly 2270.

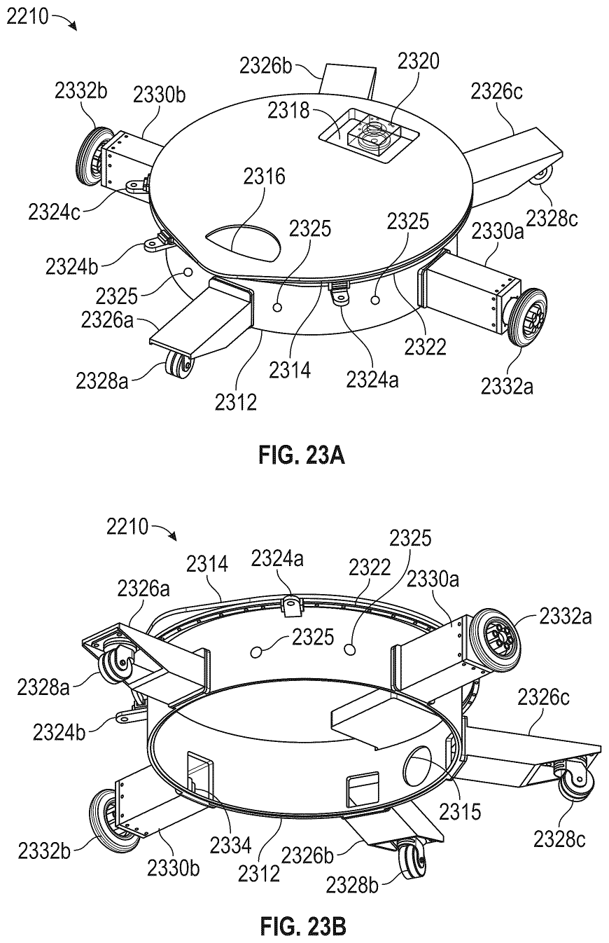

The body assembly 2210 can include wheels (motorized and/or caster wheels) that support the body assembly 2210 (and the entire apparatus 2200) on an angled surface (e.g., the angled surface 2106 of FIG. 21). In some embodiments, the body assembly 2210 can have a sufficient weight and define a center of mass such that the body assembly 2210 does not tip during operation of the apparatus 2200 (e.g., while moving the end effector assembly 2270 relative to the body assembly 2210) and the wheels of the body assembly 2210 remain in contact with the angled surface. Additional details of the body assembly 2210 are illustrated in and described below with reference to FIGS. 23A and 23B.

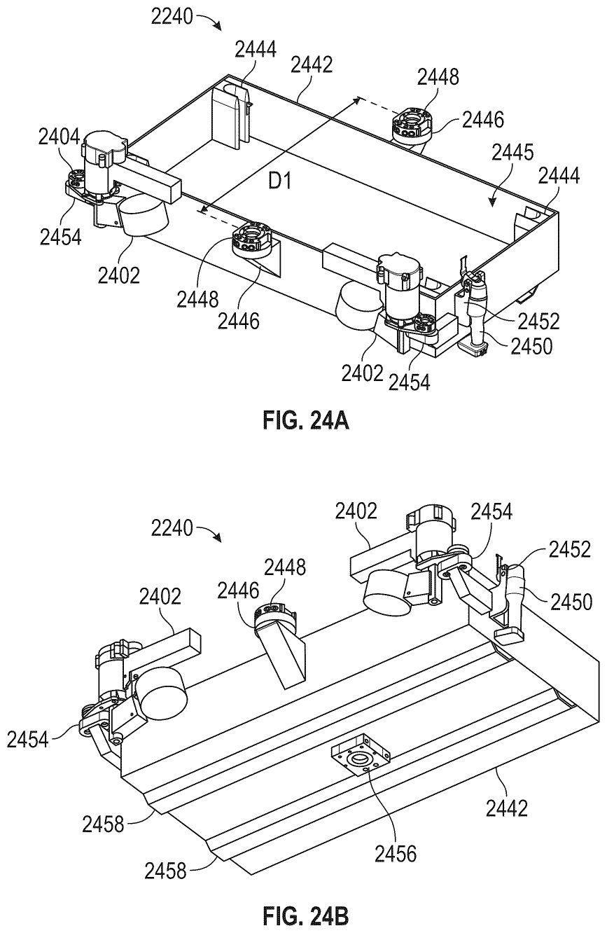

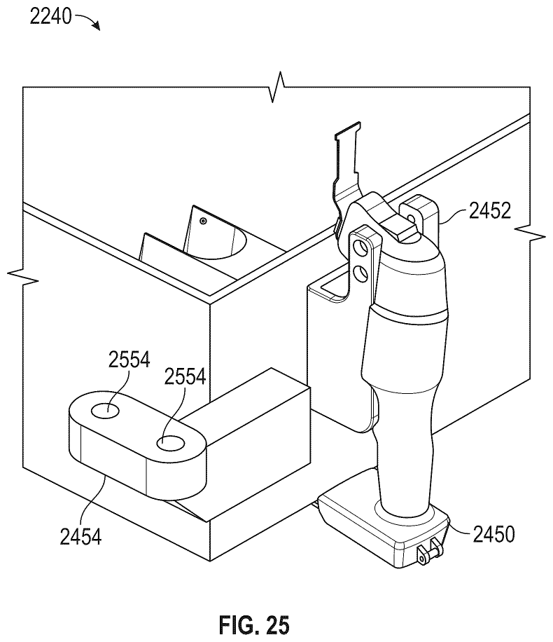

The hopper assembly 2240 can be removably attached to the body assembly 2210. The hopper assembly 2240 can carry surface materials (e.g., roof shingles) such that the apparatus 2200 has access to surface materials while operating on the angled surface without having to, e.g., return to a designated location on the angled surface each time a new surface material is needed. The hopper assembly 2240 can also serve additional functions such as cutting surface materials to desired dimensions, storing tools used by the end effector assembly 2270, etc. Additional details of the hopper assembly 2240 are illustrated in and described below with reference to FIGS. 24A-25.

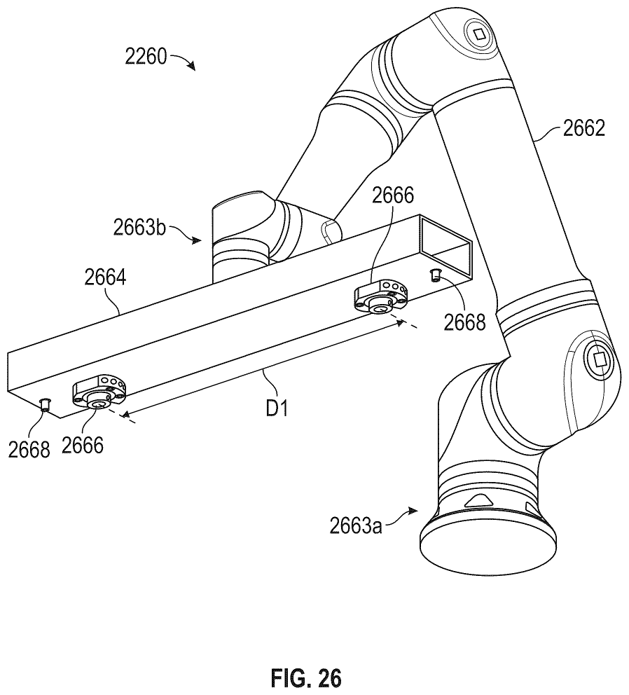

The arm assembly 2260 can be attached between the body assembly 2210 and the end effector assembly 2270. Therefore, the arm assembly 2260 can be controlled to move the end effector assembly 2270 relative to the body assembly 2210. In some embodiments, the arm assembly 2260 can be controlled to move the end effector assembly 2270 along multiple degrees of freedom (e.g., six degrees of freedom). As illustrated in FIGS. 22A and 22B, a distal end portion of the arm assembly 2260 can have a field of reach 2202. In the illustrated example, the field of reach 2202 is a generally bean-shaped area in front of the body assembly 2210. It is appreciated that because the end effector assembly 2270 extends laterally beyond the distal end portion of the arm assembly 2260, surface materials may actually be placed beyond the illustrated field of reach 2202. The field of reach 2202 can be different in other embodiments depending on, for example, the configuration of the arm assembly 2260. Additional details of the arm assembly 2260 are illustrated in and described below with reference to FIG. 26.

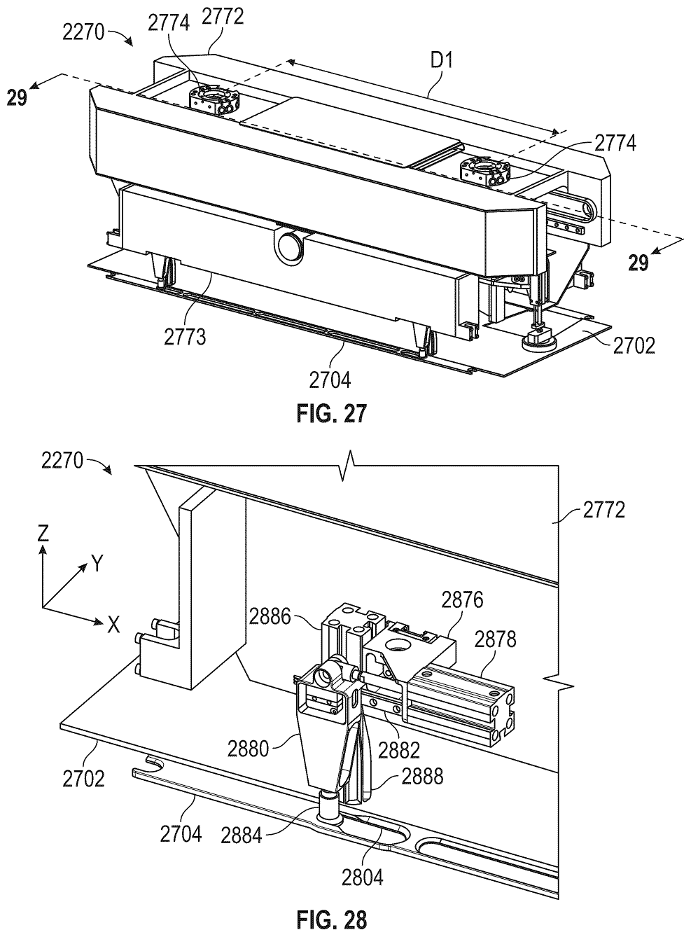

The end effector assembly 2270 can be removably attached to the distal end portion of the arm assembly 2260. The end effector assembly 2270 can include various tools (e.g., shingle lifters, suction cups, nail guns, and/or the like) for placing shingles and/or performing other desired activities on the angled surface. Notably, the arm assembly 2260 can be controlled to position the end effector assembly 2270 adjacent to (e.g., directly above) the hopper assembly 2240 so that the end effector assembly 2270 can pick up shingles from the hopper assembly 2240, use cutting tools included in the hopper assembly 2240, pick up tools (e.g., nail guns) stored on the hopper assembly 2240, and/or the like. Additional details of the end effector assembly 2270 are illustrated in and described below with reference to FIGS. 27-29.

FIGS. 23A and 23B are top perspective and bottom perspective views, respectively, of the body assembly 2210, configured in accordance with embodiments of the present technology. Referring to FIGS. 23A and 23B together, the body assembly 2210 can include a body portion 2312, one or more caster wheels (individually labeled 2328a-c, collectively referred to as “the caster wheels 2328”), one or more motorized wheels (individually labeled 2332a-b, collectively referred to as “the motorized wheels 2332”), and a quick disconnect tool 2320.

In the illustrated embodiment, the body portion 2312 is generally cylindrical and hollow in shape (as seen in FIG. 23B), and includes a top portion 2314. In particular, the cylindrical portion of the body portion 2312 can include an aperture 2315 (FIG. 23B) for receiving a cable (e.g., the power and signal cable 2130 of FIG. 21) therethrough and additional apertures for receiving wires connected to motors for the motorized wheels 2332, as discussed in further detail herein. The top portion 2314, shaped generally as a disc, can include an aperture 2316. The aperture 2316 can define where the arm assembly 2260 can be coupled to the body assembly 2210 (e.g., the arm assembly 2260 can be coupled to the top portion 2314 over the aperture 2316), and can receive wires connected to the arm assembly 2260 therethrough. Therefore, the hollow space of the body portion 2312 (as seen in FIG. 23B) can serve as a cable connections and management space.

The top portion 2314 can also include a recess 2318 for housing the quick disconnect tool 2320. The quick disconnect tool 2320 can be used to quickly and easily attach or detach the hopper assembly 2240 to or from the top portion 2314 of the body assembly 2210 (e.g., by interfacing with another quick disconnect tool part of the hopper assembly 2240, as discussed in further detail below with reference to FIG. 24B). The recess 2318 can compensate for the height of the quick disconnect tool 2320 such that the hopper assembly 2240 can rest on the top portion 2314 as opposed to, e.g., having the quick disconnect tool 2320 support the weight of the hopper assembly 2240.

Each of the caster wheels 2328 can be coupled to the body portion 2312 via a corresponding caster wheel arm (individually labeled 2326a-c, collectively referred to as “the caster wheel arms 2326”), and each of the motorized wheels 2332 can be coupled to the body portion 2312 via a corresponding motor housing (individually labeled 2330a-b, collectively referred to as “the motor housings 2330,” “the housings 2330,” or “the wheel legs 2330”). Each of the motor housings 2330 can house a respective motor 2334 (one of which is partially visible in FIG. 23B) (e.g., a servo motor) for powering the corresponding motorized wheel 2332. As previously mentioned, the body portion 2312 can include apertures interfacing the motors 2334 such that wires can extend therethrough. Such wires can be electrically connected, within the hollow space of the body portion 2312, to the power and signal cable extending through the aperture 2315.

In the illustrated embodiment, each of the caster wheel arms 2326 and the motor housings 2330 extend radially outward from and beyond the sidewall of the body portion 2312. This allows the body assembly 2210 to keep its profile defined by the cylindrical body portion 2312 small while maximizing its surface contact area defined by the caster wheels 2328 and the motorized wheels 2332. Having a relatively small profile defined by the cylindrical body portion 2312 can maximize the area of the angled surface that the apparatus 2200 can place shingles on, etc. For example, the apparatus 2200 may place shingles at least partially in the space between the caster wheel arms 2326 and the motor housings 2330. Conversely, having a large surface contact area defined by the caster wheels 2328 and the motorized wheels 2332 can reduce the risk of the body assembly 2210 tipping over during operation. Also, in particular, the motor housings 2330 extend radially outward from opposite sides of the sidewall of the body portion 2312 such that the motor housings 2330 (and thus the motorized wheels 2332) are aligned along a wheel axis. Alignment of the motorized wheels 2332 along the wheels axis enables easier control of the motorized wheels 2332 to move the apparatus 2200 along a curved path, rotate in place, and/or the like.

The body assembly 2210 can further include a rail 2322, a plurality of cable connectors (individually labeled 2324a-c, collectively referred to as “the cable connectors 2324”), and one or more sensors 2325. The rail 2322 can be fixedly coupled to the sidewall of the body portion 2312 and/or an underside of the top portion 2314 thereof. The rail 2322 can have a form factor corresponding to the geometry of the body portion 2312 (e.g., circular). As shown, the rail 2322 can be positioned above the caster wheel arms 2326 and the motor housings 2330 extending radially outward from the body portion 2312. The cable connectors 2324 can each be slidably coupled to the rail 2322 and include an aperture (or other feature, such as a clamp) that enables a corresponding cable (e.g., the cables 2108 of FIG. 21) to be attached thereto. Therefore, when operating as part of a system (e.g., the system 2100 of FIG. 21), the cables can extend radially outward from the body portion 2312, via corresponding ones of the cable connectors 2324, and above the caster wheel arms 2326 and the motor housings 2330.

The one or more sensors 2325 can be mounted to the sidewall of the body portion 2312 and face generally radially outward therefrom. In some embodiments, the one or more sensors 2325 includes multiple groups of sensors 2325 distributed circumferentially and at least partially around the body portion 2312. For example, the sensors 2325 can be arranged to cover 360 degrees or nearly 360 degrees around the body assembly 2210. As a non-limiting example, three groups of three sensors 2325 each can be arranged around the body portion 2312. The sensors 2325 can be cameras, distance sensors (e.g., laser-based), and/or the like, and can be used to determine a current position and/or orientation of the body assembly 2210. As discussed in further detail below with reference to FIGS. 31A-32, in some embodiments, the sensors 2325 can use markings on the anchor assemblies as reference points to determine the position and/or orientation of the body assembly 2210. In such embodiments, the sensors 2325 can be arranged in a manner that supports keeping the anchor assemblies within the range of the sensors 2325.

In operation, the motorized wheels 2332 and cables attached to corresponding ones of the cable connectors 2324, by controlling the motors 2334 and motors included in the anchor assemblies, respectively, can facilitate moving the body assembly 2210 across the angled surface. In some embodiments, only the motorized wheels 2332 are used to position and orient the body assembly 2210, and the cables are used only to counterbalance the weight of the apparatus 2200. In other embodiments, the motorized wheels 2332 and the cables are controlled in a synchronized manner to position and orient the body assembly 2210. The caster wheels 2328, which are generally evenly distributed around the body portion 2312 with the motorized wheels 2332, can help keep the body assembly 2210 balanced and steady on the angled surface during operation.

FIGS. 24A and 24B are top perspective and bottom perspective views, respectively, of the hopper assembly 2240, configured in accordance with embodiments of the present technology. Referring to FIGS. 24A and 24B together, the hopper assembly 2240 can include a hopper 2442, a pair of first quick disconnect tools 2448, a second quick disconnect tool 2456 (FIG. 24B), and a cutting tool 2450.

The hopper 2442 can have a bottom and sidewalls defining a cavity 2445 for storing roof shingles (or other surface materials) therein. While the hopper 2442 is generally rectangular in the illustrated embodiment, the hopper 2442 can have other shapes in other embodiments. The hopper 2442 can include a set of fixtures 2444 arranged at the corners thereof. Similar to the first set of fixtures 720 and the second set of fixtures 730 illustrated in and described above with reference to FIG. 7, the set of fixtures 2444 can keep spacers (e.g., the spacers 740 illustrated in and described above with reference to FIGS. 7-8B), and thereby shingles positioned on such spacers, secure within the cavity 2445 of the hopper 2442.

The hopper assembly 2240 can also include support structures 2446 that the pair of first quick disconnect tools 2448 can be mounted on. In particular, the support structures 2446 can be coupled to sidewalls of the hopper 2442 and positioned such that the distance D1 between the first quick disconnect tools 2448 is equal to the distance between corresponding quick disconnect tools on the arm assembly 2260, as described in further detail below with reference to FIG. 26. Therefore, as also described in further detail below, the arm assembly 2260 can be used to lift, transport, place, and otherwise move the hopper assembly 2240. While in the illustrated embodiment the support structures 2446 are positioned directly opposite one another across the hopper 2442, the support structures 2446 can be positioned elsewhere along the hopper 2442 (e.g., positioned diagonally across the hopper 2442) to achieve the distance D1 that corresponds to the distance between the corresponding quick disconnect tools on the arm assembly 2260, accounting for the dimensions of the hopper 2442.

The hopper assembly 2240 can further include one or more tool mounts 2454 and a cutter mount 2452, each coupled to the sidewall of the hopper 2442. The one or more tool mounts 2454 that can support one or more tools, such as nail guns 2402 in the illustrated embodiment. The tools supported on the one or more tool mounts 2454 can be used by the end effector assembly 2270. In some embodiments, the tools can include or be attached to a dedicated quick disconnect tool 2404 so that, for example, the arm assembly 2260 can bring the end effector assembly 2270 adjacent to the hopper assembly 2240 and the end effector assembly 2270 can, using its own quick disconnect tools, “pick up” the tools as needed from the one or more tool mounts 2454. The cutter mount 2452 can support the cutting tool 2450.

Referring momentarily to FIG. 25, which is an enlarged perspective view of the hopper assembly 2240, the illustrated tool mount 2454 includes two apertures 2554 (or openings, holes, recesses, and/or the like). The two apertures 2554 can be sized and spaced apart to receive corresponding protrusions on or coupled to the nail gun 2402 or other tool. Thus, the tool mount 2454 can securely and releasably support tools for the end effector assembly 2270. The cutting tool 2450 can be in a fixed position relative to the hopper 2442 via the cutter mount 2452, and can include a blade or other component that can cut through a roof shingle or other surface material. As discussed in further detail herein, in operation, the end effector assembly 2270 can pick up a shingle (e.g., via corresponding spacers, via suction cups) and move the shingle across the cutting tool 2450 such that the cutting tool 2450 can slice through the moving shingle while the cutting tool 2450 remains in the fixed position relative to the hopper 2442. The arm assembly 2260 can be controlled to move the end effector assembly 2270 in a desired manner relative to the cutting tool 2450 to cut shingles to desired shapes and dimensions.

It is appreciated that the tool mount 2454, the cutter mount 2452, and the cutting tool 2450 shown in FIG. 25 are merely illustrative examples, and that each can have different configurations in accordance with embodiments of the present technology. For example, the tool mount 2454 can include a different number of the apertures 2554, or include a different mechanism for supporting the nail gun 2402 or other tools, such as magnets, grippers, and/or the like.

Referring now to FIG. 24B, the second quick disconnect tool 2456 can be coupled to an underside of the hopper 2442. The second quick disconnect tool 2456 can interface the quick disconnect tool 2320 of the body assembly 2210 (FIG. 23A) so that the hopper assembly 2240 can be removably and easily attached to the body assembly 2210. Also, in the illustrated embodiment, the underside of the hopper 2442 includes one or more ribs or protrusions 2458. The height of the protrusions 2458 can correspond to the height of the second quick disconnect tool 2456 so that when the second quick disconnect tool 2456 is coupled to the quick disconnect tool 2320 of the body assembly 2210, the top portion 2314 of the body assembly 2210 and the protrusions 2458 contact one another and support the weight of the hopper assembly 2240, as opposed to, e.g., having the second quick disconnect tool 2456 and the quick disconnect tool 2320 support the weight thereof.

FIG. 26 is a bottom perspective view of the arm assembly 2260, configured in accordance with embodiments of the present technology. The arm assembly 2260 can include an arm 2662 having a proximal end portion 2663a and a distal end portion 2663b opposite the proximal end portion 2663a, and a retriever 2664 coupled to the distal end portion 2663b of the arm 2662.

In the illustrated embodiment, the arm 2662 includes a plurality of rigid segments operably coupled together. The rigid segments can rotate with respect to one another to dynamically change the shape of the arm 2662, thereby achieving multiple degrees of freedom (e.g., six degrees of freedom). In some embodiments, the arm 2662 is a third party robotic arm, such as from Universal Robotics. The proximal end portion 2663a of the arm 2662 can be coupled to the top portion 2314 of the body assembly 2210 (FIG. 23A), and wires for powering and controlling the arm assembly 2260 can be extended through the aperture 2316.

The retriever 2664 can include an elongate beam supporting various electronic components. For example, in the illustrated embodiment, the retriever includes a pair of quick disconnect tools 2666 and a pair of sensors 2668. The pair of quick disconnect tools 2666 can be spaced apart from one another by the distance D1-the same distance D1 separating the pair of first quick disconnect tools 2448 included in the hopper assembly 2240 (FIG. 24A). Additionally, as discussed in further detail below with reference to FIG. 27, the distance D1 can also correspond to the distance between quick disconnect tools on the end effector assembly 2270. Therefore, the arm assembly 2260 can use the pair of quick disconnect tools 2666 to pick up and move the hopper assembly 2240 onto or from the body assembly 2210, pick up and move the end effector assembly 2270 to place shingles onto the angled surface, and/or the like.

The pair of sensors 2668 can be cameras (e.g., machine vision cameras), distance sensors, and/or the like, and can be positioned to face generally downward (e.g., in the same direction as the pair of quick disconnect tools 2666. In the illustrated embodiment, the pair of sensors 2668 are positioned on either side of and aligned with the pair of quick disconnect tools 2666. Electronics associated with the pair of sensors 2668 (e.g., microcontrollers) can be stored and remain protected inside the elongate beam. In operation, the pair of sensors 2668 can be used to identify the type, position, and orientation of the object to be picked up (e.g., the hopper assembly 2240, the end effector assembly 2270), determine whether a shingle has been picked up properly, ensure proper cutting of a shingle via the cutting tool 2450, and/or the like.

It is appreciated that the illustrated arm assembly 2260 and the components thereof are merely examples, and that the components can have different configurations in other embodiments. For example, the arm 2662 can include semi-rigid or flexible components that can bend (e.g., a tentacle-like robotic appendage). In another example, the pair of quick disconnect tools 2666 and the pair of sensors 2668 can be mounted on a component other than the illustrated elongate beam. In yet another example, the pair of sensors 2668 can be arranged differently relative to the of quick disconnect tools 2666.

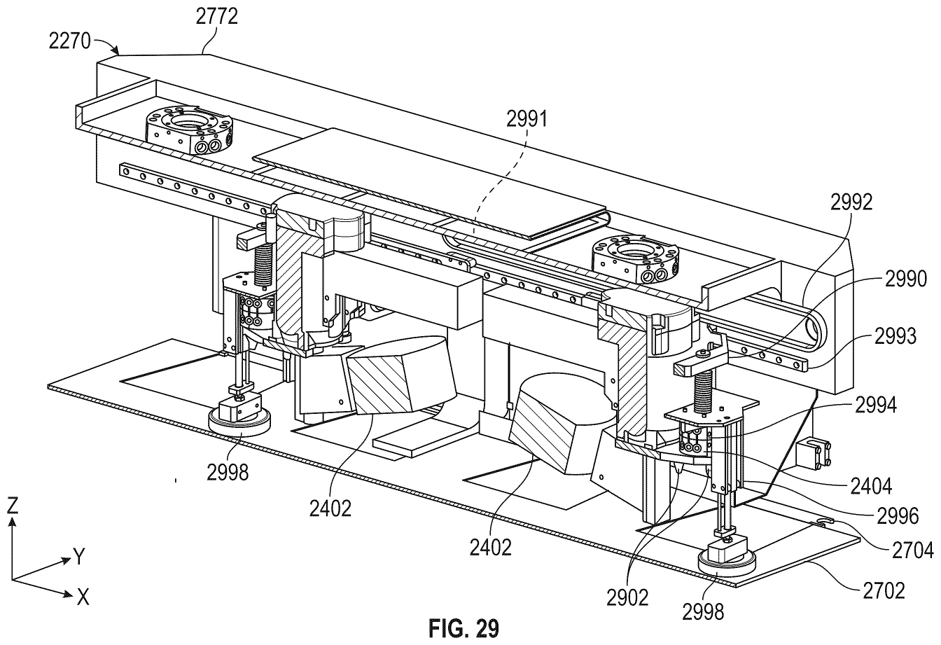

FIG. 27 is a perspective view of the end effector assembly 2270, configured in accordance with embodiments of the present technology. The end effector assembly 2270 can include a main frame 2772, a pair of quick disconnect tools 2774, and a pair of side enclosures 2773. The main frame 2772 can house the various other components of the end effector assembly 2270 described in further detail below with reference to FIG. 29. The pair of quick disconnect tools 2774 can be positioned on an upper surface of the main frame 2772, and can be separated from one another by the distance D1—the same distance separating the pair of quick disconnect tools 2666 of the arm assembly 2260 (FIG. 26). Therefore, the arm assembly 2260 can be maneuvered to pick up or release the end effector assembly 2270 by interfacing the pair of quick disconnect tools 2666 with the pair of quick disconnect tools 2774. Notably, in the illustrated embodiment, the main frame 2772 is shaped and sized to avoid obscuring the field of view of the sensors 2668 of the arm assembly 2260. The pair of side enclosures 2773 can be coupled to the sides of the main frame 2772 and can house the components described in further detail below with reference to FIG. 28. As discussed in further detail herein, in operation, the end effector assembly 2270 can be carried by the arm assembly 2260 to pick up a shingle 2702 using a pair of spacers 2704, apply the shingle 2702 top the angled surface (e.g., attach the shingle 2702 to a roof using nails), and release the shingle 2702 by moving the pair of spacers 2704 relative to the shingle 2702.

FIG. 28 is an enlarged perspective view of the end effector assembly 2270. More specifically, FIG. 28 illustrates a set of components enclosed by one of the side enclosures 2773, which is omitted for illustrative purposes only. It is appreciated that the end effector assembly 2270 can include multiple sets of components described herein, such as two sets housed in each of the side enclosures 2773 for a total of four sets.

As shown, the end effector assembly 2270 can include a mount 2876, a first actuator 2878, a pin sled 2880, a rail 2882, and a gripper pin 2884. The mount 2876 can be coupled to the side of the main frame 2772 and can serve as a support for mounting one or more of the other components of the set described herein. The first actuator 2878 (e.g., a pneumatic actuator) can be coupled to the mount 2876 and can be operable to move the pin sled 2880 along a lateral axis (e.g., the x-axis). In particular, the pin sled 2880 can be mounted to move along the rail 2882, which extends along the lateral axis (e.g., the x-axis). The gripper pin 2884 can be coupled to a lower end of the pin sled 2880, and can be shaped and sized to fit in a recess or aperture 2804 of the spacer 2704. The aperture 2804 can be similar to the second apertures 850 of the spacer 740 (FIGS. 8A and 8B), and the gripper pin 2884 can have a chamfered edge similar to the chamfered edge 1144 of the gripper 944 (FIG. 11). Therefore, discussion of how the gripper pin 2884 engages the aperture 2804 of the spacer 2704 is omitted herein.

In some embodiments, the pin sled 2880 can include a mechanism for detecting whether the gripper pin 2884 has come into contact with the spacer 2704. For example, a movable rod can extend through the pin sled 2880 and be exposed at a distal end of the gripper pin 2884, and an associated sensor (also at least partially housed in the pin sled 2880) can measure movement and/or a reaction force exerted by the movable rod (e.g., along the z-axis) to detect whether the movable rod has come into contact with the spacer 2704. Detecting such contact can facilitate engagement between the gripper pin 2884 and the spacer 2704 for properly picking up or releasing the shingle 2702.

The end effector assembly 2270 can also include a second actuator 2886 and a pusher rod 2888. The second actuator 2886 (e.g., a pneumatic actuator) can be coupled to the mount 2876 and/or the side of the main frame 2772, and can be operable to move the pusher rod 2888 along a vertical axis (e.g., the z-axis). A lower end of the pusher rod 2888 can contact the shingle 2702 to, e.g., keep the shingle 2702 on the angled surface while the end effector assembly 2270 is removing the spacers 2704 from underneath the shingle 2702, applying nails to the shingle 2702, and/or the like.

FIG. 29 is a perspective cutaway view of the end effector assembly 2270 along plane 29-29 in FIG. 27. The end effector assembly 2270 can include a pair of tool support frames 2990, a pair of motors 2991 (one of which is obscured from view, the other not included in FIG. 29), a pair of drive belts 2992 (one of which is illustrated in FIG. 29), and a pair of rails 2993 (one of which is illustrated in FIG. 29; also referred to as “the bars 2993”). The pair of tool support frames 2990 is arranged along the x-axis, as shown. The pair of motors 2991, the pair of drive belts 2992, and the pair of rails 2993 can be arranged along the y-axis such that one of each pair is illustrated in FIG. 29, and the other of each pair is cut away and thus not shown in FIG. 29.

Referring to the illustrated one of each pair, the motor 2991 (obscured from view by the top surface of the main frame 2772 in FIG. 29), the drive belt 2992, and the rail 2993 can each be coupled to one inner side of the main frame 2772. More specifically, the motor 2991 can be coupled to drive the drive belt 2992, which forms a loop extending generally along the x-axis. The rail 2993 extends adjacent to the drive belt 2992 and also generally along the x-axis. The tool support frame 2990 can be coupled to be driven by the drive belt 2992 and to slide along the rail 2993. In particular, the illustrated drive belt 2992 extends substantially on the right side of the main frame 2772, and thus above the tool support frame 2990 on the right side of FIG. 29. Therefore, the tool support frame 2990 on the right hand side can be driven by the illustrated drive belt 2992 along the x-axis and along the right half of the rail 2993. On the other hand, the non-illustrated drive belt 2992 can extend substantially on the left side of the main frame 2772, and thus above the tool support frame 2990 on the left side of FIG. 29. Therefore, the tool support frame 2990 on the left hand side can be driven by the non-illustrated drive belt 2992 along the x-axis and along the left half of the rail 2993. It is appreciated that each of the pair of tool support frames 2990 can be supported on both of the pair of rails 2993, which are spaced apart from one another along the y-axis.

The end effector assembly 2270 can further include a pair of quick disconnect tools 2994, a pair of third actuators 2996, and a pair of suction cups 2998. Each quick disconnect tool 2994 can be coupled to a corresponding one of the pair of tool support frames 2990. The nail gun 2402, first introduced in FIGS. 24A and 24B, can be releasably coupled to the corresponding tool support frame 2990 via the quick disconnect tool 2404, which can interface with the quick disconnect tool 2994, as shown. Additionally, the nail gun 2402 can include or be coupled to a pair of protrusions 2902, which can be sized, shaped, and spaced apart from one another to fit in the two apertures 2554 of the tool mount 2454 (FIG. 25). Therefore, by engaging or disengaging the quick disconnect tools 2994 and 2404, the end effector assembly 2270 can pick up or place the nail gun 2402 (or other tool) from or onto the hopper assembly 2240.

Each third actuator 2996 can be coupled to a corresponding one of the pair of tool support frames 2990, and can be operable to move a corresponding one of the pair of suction cups 2998 along the z-axis. The suction cups 2998 can be used in addition to or in place of the spacers 2704 to lift or release the shingle 2702. In some embodiments, the suction cups 2998 can be actuated to engage or release the shingle 2702. Because the nail guns 2402 and the suction cups 2998 are coupled to the corresponding tool support frames 2990, the motors 2991 and the drive belts 2992 can be operated to move the nail guns 2402 and the suction cups 2998 along the x-axis.

Referring to FIGS. 27-29 together, in operation, the end effector assembly 2270 can be operated to pick up the shingle 2702 from the hopper 2442 (FIGS. 24A and 24B), place the shingle 2702 at a desired location on the angled surface, and affix the shingle 2702 to the angled surface at that location. For example, in some embodiments, the end effector assembly 2270 can pick up the shingle 2702 by using the gripper pins 2884 (FIG. 28) to engage the spacers 2704 positioned at least partially underneath the shingle 2792 and/or by actuating the suction cups 2998. In some embodiments, the end effector assembly 2270 can keep the shingle 2702 on the angled surface by pressing the pusher rod 2888 against the shingle 2702 (e.g., to clamp the shingle 2702 onto the angled surface. In some embodiments, the end effector assembly 2270 can affix the shingle 2702 onto the angled surface by actuating the nail guns 2402. As discussed above, the motors 2991 can be operated to move the nail guns 2402 relative to the shingle 2702 such that nails can be applied to multiple different spots on the shingle 2702. Notably, in the illustrated embodiment, the main frame 2772 is shaped to avoid obscuring the field of view of the sensors 2668 included in the arm assembly 2260 such that the sensors 2668 can determine, e.g., whether the shingle 2702 has been placed properly, where to apply nails, and/or the like. In some embodiments, after affixing the shingle 2702 to the angled surface, the end effector assembly 2270 can return the spacers 2704 to, e.g., the hopper 2442.

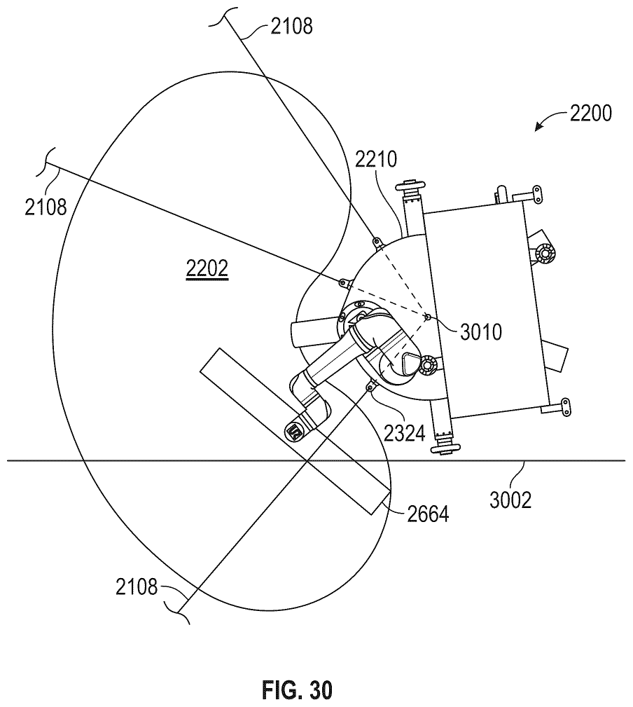

FIG. 30 illustrates operation of the apparatus 2200 at a high level, in accordance with embodiments of the present technology. It is appreciated that the end effector assembly 2270 is omitted for illustrative purposes only. As shown, the cables 2108 can be connected to the body assembly 2210 via the cable connectors 2324 (three cables 2108 are shown connected to corresponding ones of three cable connectors 2324). Because the anchor assemblies 2120 are fixed in position relative to the angled surface (see FIG. 21) and the cable connectors 2324 are free to slide along the rail 2322 (FIGS. 23A and 23B), as the body assembly 2210 moves across the angled surface, the angles at which the cables 2108 extend from the body assembly 2210 can change to keep the cables 2108 straight and under tension. Also, while under tension, the cables 2108 apply a pulling force on the body assembly 2210 along axes that extend through and intersect at a common point 3010 in the body assembly 2210. Therefore, while the cables 2108 can apply a net force on the apparatus 2200 (e.g., to support the weight thereof on the angled surface), the cables 2108 cannot apply a moment on the apparatus 2200 (e.g., to rotate the apparatus 2200 on the angled surface).

The motorized wheels 2332 can be operated to reposition and/or reorient the body assembly 2210. For example, in the illustrated embodiment, the two motorized wheels 2332 can be operated at the same speed or at different speeds to move the body assembly 2210 linearly or turn/rotate, respectively. In some embodiments, the motorized wheels 2332 provide the primary force and control for moving the body assembly 2210 across the angled surface, while the cables 2108 counterbalance at least some of the weight of the apparatus 2200. In other embodiments, individual ones of the cables 2108 can be controlled via the corresponding anchors, as discussed in further detail below with reference to FIGS. 31A-32. In some embodiments, the wheel axis (which, as discussed above with reference to FIGS. 23A and 23B), the motorized wheels 2332 are aligned along) also intersects with the common point 3010 in the body assembly 2210. Such an arrangement can minimize any undesired effects of tension in the cables 2108 on operation of the motorized wheels 2332.

Also, in the illustrated embodiment, the horizontal line 3002 represents a boundary on the angled surface for the body assembly 2210. For example, the horizontal line 3002 can be an edge of the angled surface (e.g., the eave of a roof). In another example, the horizontal line 3002 can be a virtual boundary, such as a line spaced apart from the edge of the angled surface for a higher degree of safety. As shown, the field of reach 2202 of the retriever 2664 can extend beyond the horizonal line 3002 (e.g., the boundary of the body assembly 2210). Therefore, the end effector assembly 2270 (not shown in FIG. 30) can be used to, e.g., place shingles along edges of a roof without positioning the body assembly 2210 thereat, decreasing the risk of the apparatus 2200 tipping over and falling.

FIGS. 31A and 31B are perspective and top views, respectively, of an anchor assembly 3100, configured in accordance with embodiments of the present technology. The anchor assembly 3100 can be an example of the anchor assemblies 2120 of FIG. 21. Referring to FIGS. 31A and 31B together, the anchor assembly 3100 can include a base 3110, one or more electrical connectors 3120, a drum 3130, and a cable shield 3140.

The base 3110 can have a bottom surface (e.g., flat, curved) that interfaces with the angled surface, and features for securely and releasably coupling to the angled surface. For example, in some embodiments, the base 3110 includes apertures (not shown) sized to receive bolts and/or other fasteners. In the illustrated embodiment, the base 3110 has a generally rectangular form factor having a pattern 3114 on a sidewall thereof and one or more buttons 3112 (two are illustrated) on a top surface thereof. When installing the anchor assembly 3100 on the angled surface, the anchor assembly 3100 can be oriented such that the pattern 3114 generally faces where the apparatus (e.g., the apparatus 2200) would be operating on the angled surface. The sensors 2325 (FIGS. 23A and 23B) can be used to detect the pattern 3114 on each anchor assembly 3100 (in systems including multiple anchor assemblies 3100), and given the known installed position of the anchor assemblies 3100 relative to the angled surface, the sensors 2325 can be used to determine a current position and/or orientation of the body assembly 2210. The pattern 3114 can be selected to be visible or otherwise compatible with the sensors 2325, which may be machine vision cameras. The one or more buttons 3112 can be manually actuated to wind or unwind the cable 2108 around or from the drum 3130, as discussed in further detail herein.

The one or more electrical connectors 3120 can be coupled to the base 3110. In the illustrated embodiment, for example, two electrical connectors 3120 are coupled to two corners of the rectangular base 3110. The electrical connectors 3120 can be electrically connected to various electronics included in the anchor assembly 3100, described in further detail herein. Thus, the electrical connectors 3120 can be used to form a daisy chain with other anchor assemblies such that, e.g., a first one of the two electrical connectors 3120 is coupled to an electrical connector of another anchor assembly and a second one of the two electrical connectors 3120 is coupled to either an electrical connector of yet another anchor assembly or a data and power line. Accordingly, by electrically coupling multiple anchor assemblies 3100, a single data and power line can be used to power and individually control the multiple anchor assemblies 3100.

The drum 3130 can be generally cylindrical in shape and can extend vertically from and be rotatably coupled to the top surface of the base 3110. As best shown in FIG. 31A, the cable 2108 can be wound around an outer surface of the drum 3130 in a spiral. The drum 3130 can partially enclose a ring gear 3132, a sun gear 3134, a planet gear 3135, and a transmission housing 3136. The ring gear 3132 can be coupled to an inner surface of the drum 3130 (e.g., along an inner rim at the top of the drum 3130). Each of the sun gear 3134 and the planet gear 3135 can be rotatably coupled to a top surface of the transmission housing 3136, and in particular, the planet gear 3135 can be in a gear mesh arrangement with both the sun gear 3134 and the ring gear 3132. As best shown in FIG. 31B, the transmission housing 3136 occupies only a portion of the space inside the drum 3130, leaving a cavity 3138 that can be used for, e.g., storing various electronics such as batteries, controllers, and/or the like. The base 3110 can have an opening (illustrated in FIG. 31B) at the top thereof and connecting to the cavity 3138 for wires and/or the like. In some embodiments, the anchor assembly 3100 further includes a top or cover (not shown) to fully enclose and protect the components inside the drum 3130.

The cable shield 3140 can be fixedly coupled to the base 3110 and can have the shape of a partial cylindrical shell extending around the drum 3130. As shown in FIG. 31A, the cable shield 3140 can have a height corresponding to the height of the cable 2108 when the cable is wound around the drum 3130. In FIG. 31B, the cable shield 3140 is illustrated as extending around the drum 3130 by nearly 180 degrees and is not symmetrical with, e.g., the two electrical connectors 3120. However, it is appreciated that in other embodiments, the cable shield 3140 can extend around the drum 3130 by smaller or larger angles (e.g., at least 30 degrees, 60 degrees, 90 degrees, 120 degrees, 150 degrees, 180 degrees, 210 degrees, 240 degrees, 270 degrees, 300 degrees) and/or can be positioned elsewhere relative to the drum 3130.

FIG. 32 is a cross-sectional view of the anchor assembly 3100 along plane 32-32 in FIG. 31B. As shown, the anchor assembly 3100 can further include a motor 3250, a gear box 3260, and a sensor 3270. The motor 3250 can be housed in the base 3110, such as underneath the cavity 3138. In some embodiments, the motor 3250 is a servo motor. The gear box 3260 can be stored in the base 3110 and/or the transmission housing 3136, and be operably coupled between the motor 3250 and the sun gear 3134. In the illustrated embodiment, the gear box 3260 is a right angle gear box, with the motor 3250 oriented along a horizontal axis and the sun gear 3134 oriented along a vertical axis. In some embodiments, the gear box 3260 provides a gear reduction by at least 10:1, 15:1, 20:1, 25:1, 30:1, or more. The sun gear 3134 and/or the planet gear 3135 can provide additional gear reduction, such as by at least 2:1, 4:1, 6:1, or more.

The sensor 3270 can be stored inside the transmission housing 3136 and operably coupled to the sun gear 3134 and measure parameters thereof. For example, the sensor 3270 can be an inline rotational torque sensor configured to measure the torque acting on the sun gear 3134. Thus, given the known gear ratio between the sun gear 3134 and the ring gear 3132, the measured torque can be used to determine the tension in the cable 2108 at any given moment. In other embodiments, additional and/or alternative sensors can be included, such as a rotational position sensor that measures a rotational position of the sun gear 3134 and thereby allows determining a length of the cable 2108 extending between the anchor assembly 3100 and the apparatus 2200, a rotational speed sensor that measures a rotational speed of the sun gear 3134 and thereby allows determining a payout or retraction rate of the cable 2108. In some embodiments, the sensor 3270 can be operably coupled to a controller or other component in the cavity 3138 wirelessly or via a wired connection (e.g., a wire extending through a port on the side of the transmission housing 3136.

In operation, the motor 3250 can be operated to rotate the drum 3130 and thereby wind or unwind the cable 2108 around or from the drum 3130 by a desired amount and/or speed. As previously mentioned, multiple ones of the anchor assembly 3100 (e.g., two, three, four) can be operably coupled to one another via the one or more electrical connectors 3120 to form a daisy chain, and at least one of the anchor assemblies 3100 can be operably coupled to a controller (e.g., the controller 2101 of FIG. 21) and/or a power source. As the apparatus 2200 moves across the angled surface using the motorized wheels 2332 (FIGS. 23A and 23B), the motor 3250 (e.g., a servo motor) can be controlled and operated to keep the corresponding cable 2108 under tension while also allowing the apparatus to reposition and/or reorient itself.

For example, if the apparatus is moving away from a particular anchor assembly 3100, the sensor 3270 of that particular anchor assembly 3100 may detect an increase (e.g., above a threshold amount) in the measured torque due to the apparatus pulling on the cable 2108. In response, the controller can operate the motor to rotate the drum 3130 such that the cable 2108 unwinds from the drum 3130 enough to allow the apparatus to move across the angled surface as desired, but not too much that there is slack in the cable 2108 (which may be detected upon a decrease below a threshold amount in the measured torque). Therefore, by carefully controlling the rotation of the drum 3130, the anchor assemblies 3100 can, in tandem, keep the cables 2108 under tension and thereby provide appropriate pulling forces to counteract the gravitational force acting on the apparatus as the apparatus operates on the angled surface. The cable shield 3140 can prevent the cables 2108 from unwinding from the drum 3130 improperly while also allowing the cables 2108 to extend from their corresponding anchor assemblies 3100 at various angles to accommodate various positions of the apparatus on the angled surface.

Notably, the apparatus 2200 of FIGS. 22-29, and in particular the body assembly 2210, does not include a cable management assembly (e.g., motors, drums, winches, and/or the like) configured to reel in or reel out the cables 2108. Rather, as discussed above with reference to FIGS. 31A-32, the anchor assemblies 3100 include such cable management assemblies. Therefore, the apparatus 2200 is expected to be more lightweight and smaller in size compared to apparatuses that do include one or more cable management assemblies. Locating the cable management assemblies in the anchor assemblies 3100 instead of in the apparatus 2200 is also expected to significantly reduce power and control requirements of the apparatus 2200, allowing fewer electrical cables to be connected to the apparatus 2200 during operation, thereby facilitating movement of the apparatus 2200 on the angled surface.

### III. METHODS OF OPERATING AN APPARATUS AND ANCHOR ASSEMBLIES TO PLACE SURFACE MATERIALS ON AN ANGLED SURFACE

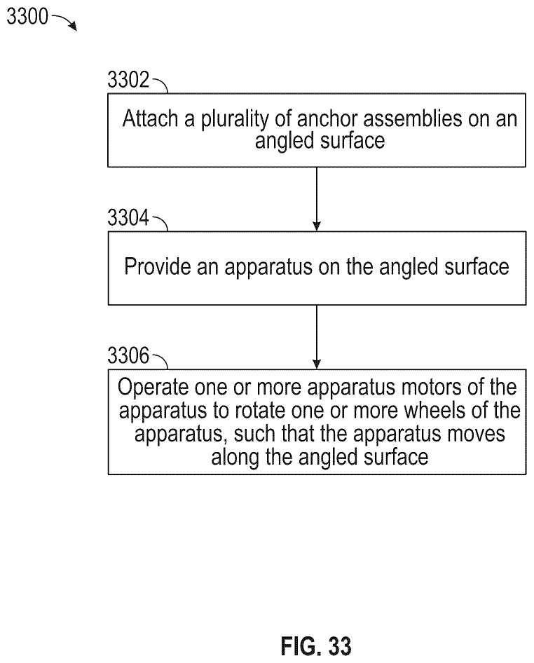

FIG. 33 is a flowchart illustrating a method 3300 of operating an apparatus to place surface materials on an angled surface in accordance with some embodiments of the present technology. While the steps of the method 3300 are described below in a particular order, one or more of the steps can be performed in a different order or omitted, and the method 3300 can include additional and/or alternative steps. Additionally, although the method 3300 may be described below with reference to the embodiments of the present technology described herein, the method 3300 can be performed with other embodiments of the present technology.

The method 3300 begins by attaching a plurality of anchor assemblies on an angled surface (process portion 3302). Individual anchor assemblies can include a base, a drum rotatably coupled to the base, and an anchor motor operably coupled to the drum and configured to rotate the drum relative to the base. In some embodiments, attaching the plurality of anchor assemblies comprises (i) attaching a first one of the plurality of anchor assemblies to an upper-left corner of the angled surface, (ii) attaching a second one of the plurality of anchor assemblies to an upper-middle portion of the angled surface, and (iii) attaching a third one of the plurality of anchor assemblies to an upper-right corner of the angled surface (e.g., as shown in FIG. 21).

The method 3300 continues by providing an apparatus on the angled surface (process portion 3304). The apparatus can include a body portion, one or more wheels coupled to the body portion, one or more apparatus motors operably coupled to corresponding ones of the one or more wheels, and a plurality of cable connectors coupled to the body portion. The apparatus can be coupled to the plurality of anchor assemblies via a plurality of cables each extending between a corresponding one of the plurality of anchor assemblies and a corresponding one of the plurality of cable connectors.

The method 3300 continues by operating the one or more apparatus motors to rotate the one or more wheels, such that the apparatus moves along the angled surface (process portion 3306). In some embodiments, the apparatus can be moved along a straight or curved path across the angled surface. In some embodiments, the apparatus can be moved by rotating the apparatus (e.g., in place, while moving along a path).

In some embodiments, the method 3300 continues by operating the anchor motor of each of the plurality of anchor assemblies to rotate the drum of the respective anchor assembly and thereby wind or unwind the corresponding one of the plurality of cables such that the plurality of cables remains under tension. In some embodiments, each of the plurality of anchor assemblies further includes a sensor configured to measure a torque applied on the drum of the respective anchor assembly. The measured torque can indicate a tension of the corresponding one of the plurality of cables. In some embodiments, operating the anchor motor comprises rotating the drum of the respective anchor assembly based on the measured torque.

In some embodiments, the apparatus further includes a hopper coupled to the body portion, an arm assembly coupled to the body portion, and an end effector assembly coupled to the arm assembly. In such embodiments, the method 3300 can continue by lifting, via the arm assembly and the end effector assembly, a surface material from the hopper, and applying, via the arm assembly and the end effector assembly, the surface material onto the angled surface. The surface material can be applied onto the angled surface via nails, adhesives, and/or other attachment mechanisms.

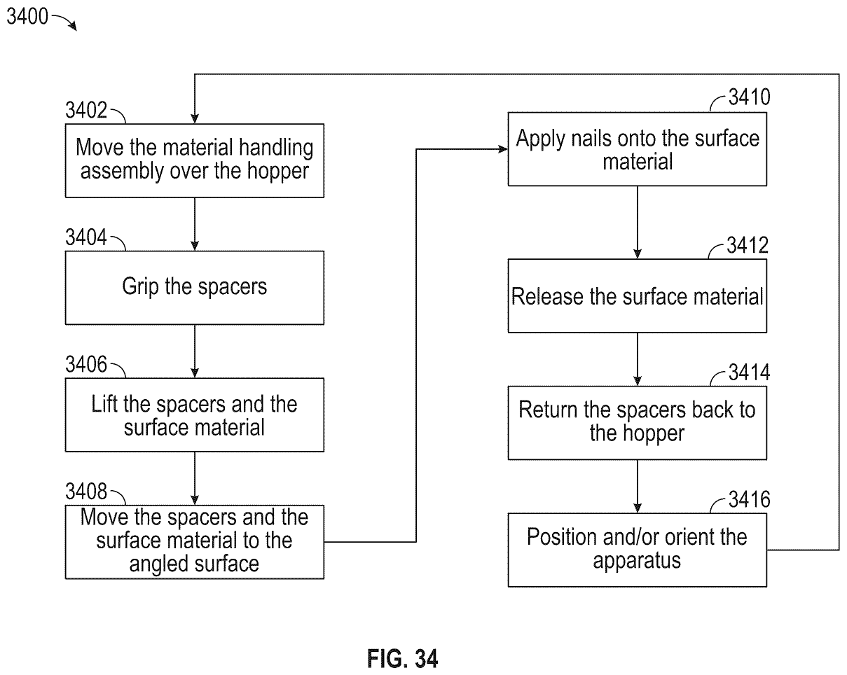

FIG. 34 is a flowchart illustrating a method 3400 of operating an apparatus and anchor assemblies to place surface materials on an angled surface. While the method 3400 is described with reference to FIGS. 1-20, the method 3400 can be practiced with other embodiments of apparatuses and/or anchor assemblies. The method 3400 can include moving the material handling assembly 430 over the hopper 440 (e.g., by operating the arm assembly 420) (process portion 3402). The method 3400 can include gripping the spacers 740 (e.g., by operating the material handling assembly 430) (process portion 3404).

The method 3400 can include lifting the spacers 740 and the surface material 401 from the hopper 440 (e.g., by operating the arm assembly 420) (process portion 3406). The method 3400 can include moving the spacers 740 and the surface material 401 to the angled surface 104 (e.g., by operating the arm assembly 420) (process portion 3408). The method 3400 can include applying nails onto the surface material 401 (e.g., by operating the nail gun assembly 930) (process portion 3410). The method 3400 can include releasing the surface material 401 (e.g., by operating the material handling assembly 430) (process portion 3412). The method 3400 can include returning the spacers 740 back to the hopper 440 (e.g., by operating the arm assembly 420) (process portion 3414). The method 3400 can include positioning and/or orienting the apparatus 400 (e.g., by operating the positioning assemblies 1900) (process portion 3416).

### IV. COMPUTER SYSTEMS

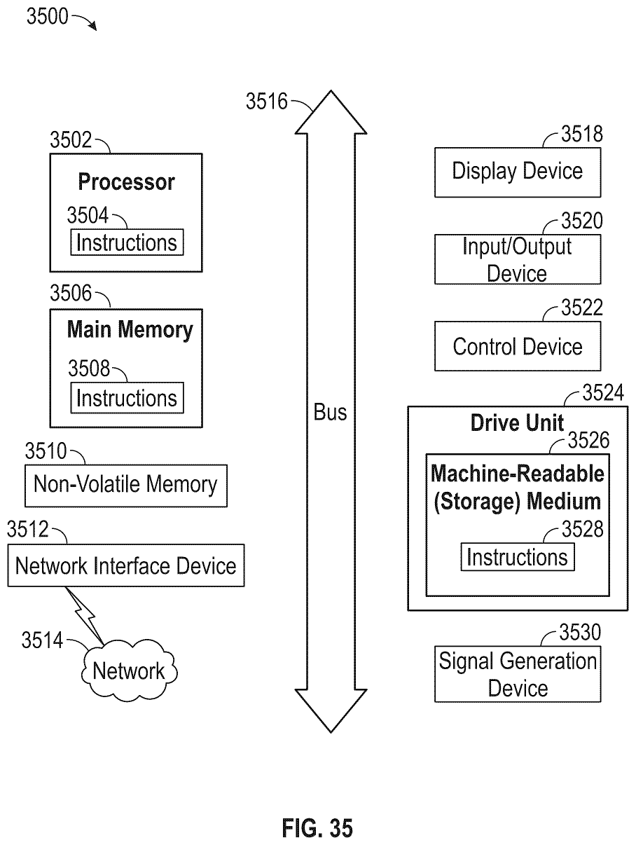

FIG. 35 is a block diagram that illustrates an example of a computer system 3500 in which at least some operations described herein can be implemented. The computer system 3500 can be implemented as part of, e.g., the controller 2101 of FIG. 21, the apparatus 2200, the anchor assembly 3100, etc. As shown, the computer system 3500 can include: one or more processors 3502, main memory 3506, non-volatile memory 3510, a network interface device 3512, video display device 3518, an input/output device 3520, a control device 3522 (e.g., keyboard and pointing device), a drive unit 3524 that includes a storage medium 3526, and a signal generation device 3530 that are communicatively connected to a bus 3516. The bus 3516 represents one or more physical buses and/or point-to-point connections that are connected by appropriate bridges, adapters, or controllers. Various common components (e.g., cache memory) are omitted from FIG. 35 for brevity. Instead, the computer system 3500 is intended to illustrate a hardware device on which components illustrated or described relative to the examples of the figures and any other components described in this specification can be implemented.

The computer system 3500 can take any suitable physical form. For example, the computing system 3500 shares a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 3500. In some implementation, the computer system 3500 can be an embedded computer system, a system-on-chip (SOC), a single-board computer system (SBC) or a distributed system such as a mesh of computer systems or include one or more cloud components in one or more networks. Where appropriate, one or more computer systems 3500 can perform operations in real-time, near real-time, or in batch mode.

The network interface device 3512 enables the computing system 3500 to mediate data in a network 3514 with an entity that is external to the computing system 3500 through any communication protocol supported by the computing system 3500 and the external entity. Examples of the network interface device 3512 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 3506, non-volatile memory 3510, machine-readable medium 3526) can be local, remote, or distributed. Although shown as a single medium, the machine-readable medium 3526 can include multiple media (e.g., a centralized/distributed database and/or associated caches and servers) that store one or more sets of instructions 3528. The machine-readable (storage) medium 3526 can include any medium that is capable of storing, encoding, or carrying a set of instructions for execution by the computing system 3500. The machine-readable medium 3526 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 3510, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 3504, 3508, 3528) set at various times in various memory and storage devices in computing device(s). When read and executed by the processor 3502, the instruction(s) cause the computing system 3500 to perform operations to execute elements involving the various aspects of the disclosure.

### V. EXAMPLES/CLAUSES

The present technology is illustrated, for example, according to various aspects described below as numbered clauses (1, 2, 3, etc.) for convenience. These are provided as examples and do not limit the present technology. It is noted that any of the dependent clauses may be combined in any combination, and placed into a respective independent clause. The other clauses can be presented in a similar manner.

1. An apparatus configured to operate on an angled surface relative to a direction of gravity, the apparatus comprising:
a body assembly including:
   a body portion,
   one or more wheels coupled to the body portion,
   one or more motors coupled to corresponding ones of the one or more wheels, wherein the one or more motors are configured to operate the one or more wheels to move the apparatus on the angled surface,
   a plurality of cable connectors coupled to the body portion, wherein individual ones of the cable connectors are configured to be coupled to corresponding cables;
an arm assembly having a proximal end portion coupled to the body portion of the body assembly and a distal end portion opposite the proximal end portion, wherein the arm assembly includes a retriever at the distal end portion; and
an end effector assembly releasably coupled to the retriever of the arm assembly, wherein the end effector assembly is configured to carry a surface material.

2. The apparatus of any one of the clauses herein, wherein the body assembly does not include a cable management assembly configured to reel a cable.

3. The apparatus of any one of the clauses herein, wherein the body assembly further includes a rail fixedly coupled to the body portion, wherein the plurality of cable connectors are each slidably coupled to the rail.

4. The apparatus of any one of the clauses herein, wherein the rail is shaped such that, when the cables coupled to the cable connectors are under tension, the cables extend along a plurality of axes that intersect at a common point in the body assembly.

5. The apparatus of any one of the clauses herein, wherein the body assembly further includes one or more motor housings coupled to an external surface of the body portion and extending radially outward from the body portion, wherein the one or more motors are housed in corresponding ones of the one or more motor housings, and wherein the one or more wheels are coupled to distal ends of corresponding ones of the one or more motor housings.

6. The apparatus of any one of the clauses herein, wherein the body assembly further includes one or more body sensors coupled to an external surface of the body portion and configured to measure at least one of a position or an orientation of the body portion relative to the angled surface.

7. The apparatus of any one of the clauses herein, wherein the body assembly further includes:
one or more caster wheel arms coupled to an external surface of the body portion and extending away from the body portion; and
one or more caster wheels coupled to distal ends of corresponding ones of the one or more caster wheels arms.

8. The apparatus of any one of the clauses herein, wherein the arm assembly further includes one or more retriever sensors coupled to the retriever.

9. The apparatus of any one of the clauses herein, wherein the end effector assembly includes:
a main frame;
a bar coupled to the main frame and extending along a lateral axis;
a drive belt positioned adjacent to the bar and extending along the lateral axis;
a motor coupled to the main frame and operable to drive the drive belt; and
a tool support frame coupled to the bar and to the drive belt, wherein the tool support frame is configured to be releasably coupled to a tool operable to apply the surface material onto the angled surface.

10. The apparatus of any one of the clauses herein, wherein the retriever includes a first pair of quick disconnect tools spaced apart from one another by a distance, and wherein the end effector assembly includes a second pair of quick disconnect tools spaced apart from one another by the distance such that the end effector assembly can be releasably coupled to the retriever of the arm assembly by engaging the first pair of quick disconnect tools with corresponding ones of the second pair of quick disconnect tools.

11. The apparatus of any one of the clauses herein, wherein the end effector assembly includes:
a main frame;
a first actuator coupled to the main frame;
a pusher rod coupled to the first actuator, wherein the first actuator is configured to move the pusher rod to press the surface material against the angled surface;
a second actuator movably coupled to the main frame; and
a suction cup coupled to the second actuator, wherein the second actuator is configured to move the suction cup to engage the surface material.

12. The apparatus of any one of the clauses herein, further comprising a hopper assembly including:
a hopper releasably coupled to the body portion of the body assembly, wherein the hopper is configured to store the surface material; and
a cutting tool coupled to a side of the hopper, wherein the cutting tool is configured to cut through the surface material.

13. The apparatus of any one of the clauses herein, further comprising a hopper assembly including:
a hopper releasably coupled to the body portion of the body assembly, wherein the hopper is configured to store the surface material; and
a first pair of quick disconnect tools coupled to the hopper and spaced apart from one another by a distance,
wherein the retriever includes a second pair of quick disconnect tools spaced apart from one another by the distance such that the hopper can be releasably coupled to the retriever of the arm assembly by engaging the first pair of quick disconnect tools with corresponding ones of the second pair of quick disconnect tools.

14. A system for operating a device on an angled surface, the system comprising:
an apparatus configured to operate on the angled surface, the apparatus including:
   a body assembly including a body portion, wheel legs coupled to and extending outward from the body portion, and wheels coupled to corresponding ones of the wheel legs, wherein the wheel legs are aligned with one another along a wheel axis;
   an arm assembly having a proximal end portion coupled to the body portion of the body assembly and a distal end portion opposite the proximal end portion, wherein the arm assembly includes a retriever at the distal end portion; and
   an end effector assembly releasably coupled to the retriever of the arm assembly, wherein the end effector assembly is configured to carry a shingle.

15. The system of any one of the clauses herein, wherein the body assembly further includes motors configured to drive corresponding ones of the wheels.

16. The system of any one of the clauses herein, wherein the body assembly further includes:
a rail fixedly coupled to the body portion;
a plurality of cable connectors each slidably coupled to the rail and configured to be coupled to corresponding cables,
wherein the rail is shaped such that when the cables coupled to the cable connectors are under tension, the cables extend along a plurality of axes that intersect with one another at a common point in the body assembly and with the wheel axis.

17. The system of any one of the clauses herein, further comprising:
a plurality of anchor assemblies configured to be attached to the angled surface along a periphery thereof, wherein each of the plurality of anchor assemblies includes a base, a drum rotatably coupled to the base, and an anchor motor operably coupled to the drum and configured to rotate the drum relative to the base;
a plurality of cables each wound around the drum of a corresponding one of the plurality of anchor assemblies and coupled to the body assembly of the apparatus; and
a controller operably coupled to the plurality of anchor assemblies, wherein the controller is configured to, for each of the plurality of anchor assemblies, operate the anchor motor such that (i) the drum rotates to wind or unwind the corresponding one of the plurality of cables and (ii) the corresponding one of the plurality of cables remains under tension and extends between the anchor assembly and the body assembly of the apparatus.

18. The system of any one of the clauses herein, wherein the anchor motor of each of the plurality of anchor assemblies comprises a servo motor housed in the base, and wherein each of the plurality of anchor assemblies further includes:
a ring gear coupled to an inner surface of the drum;
a sun gear engaged with the ring gear; and
a gear box coupled between the servo motor and the sun gear, wherein the gear box is configured to provide a gear reduction ratio of at least 20:1.

19. The system of any one of the clauses herein, wherein each of the plurality of anchor assemblies further includes a sensor configured to measure a torque applied on the drum of the respective anchor assembly, wherein the measured torque indicates a tension of the corresponding one of the plurality of cables, and wherein the controller is operably coupled to the sensor and configured to operate the anchor motor of each of the plurality of anchor assemblies based on the torque measured by the respective sensor.

20 The system of any one of the clauses herein, wherein the base of each of the plurality of anchor assemblies includes a pattern, and wherein the body assembly further includes one or more sensors coupled to the body portion and configured to detect the pattern and thereby determine a position of the body portion relative to the respective anchor assembly.

21. The system of any one of the clauses herein, further comprising spacers each configured to contact a surface material and including at least one aperture, wherein the end effector assembly includes:
a plurality of gripper pins shaped and sized to fit at least partially in one of the at least one aperture of the pair of spacers; and
a plurality of actuators operably coupled to corresponding ones of the plurality gripper pins, wherein each of the plurality of actuators is configured to move the corresponding gripper pin to engage the one of the at least one aperture, thereby enabling the arm assembly and the end effector assembly to lift the spacers and the surface material.

22. The system of any one of the clauses herein, further comprising a plurality of cables each movably coupled to the body assembly of the apparatus.

23. The system of any one of the clauses herein, further comprising:
a plurality of anchors assemblies configured to be attached to the angled surface, wherein the plurality of anchors assemblies each includes a sensor; and
a plurality of cables extending between the body assembly of the apparatus and corresponding ones of the plurality of anchor assemblies,
wherein the sensor of each anchor assembly is configured to output a value characterizing a tension of a corresponding one of the cables.

24. A method of operating an apparatus to place surface materials on an angled surface, the method comprising:
attaching a plurality of anchor assemblies on the angled surface, wherein individual anchor assemblies includes a base, a drum rotatably coupled to the base, and an anchor motor operably coupled to the drum and configured to rotate the drum relative to the base;
providing an apparatus on the angled surface, wherein the apparatus includes: a body portion,
   one or more wheels coupled to the body portion,
   one or more apparatus motors operably coupled to corresponding ones of the one or more wheels, and
   a plurality of cable connectors coupled to the body portion, wherein the apparatus is coupled to the plurality of anchor assemblies via a plurality of cables each extending between a corresponding one of the plurality of anchor assemblies and a corresponding one of the plurality of cable connectors; and
operating the one or more apparatus motors to rotate the one or more wheels, such that the apparatus moves along the angled surface.

25. The method of any one of the clauses herein, further comprising operating the anchor motor of each of the plurality of anchor assemblies to rotate the drum of the respective anchor assembly and thereby wind or unwind the corresponding one of the plurality of cables such that the plurality of cables remains under tension.

26. The method of any one of the clauses herein, wherein attaching the plurality of anchor assemblies comprises attaching a first one of the plurality of anchor assemblies to a first portion of the angled surface, attaching a second one of the plurality of anchor assemblies to a second portion of the angled surface spaced apart from the first portion, and attaching a third one of the plurality of anchor assemblies to third portion of the angled surface spaced apart from the second portion.

27. The method of any one of the clauses herein, wherein each of the plurality of anchor assemblies further includes a sensor configured to measure a torque applied on the drum of the respective anchor assembly, wherein the measured torque indicates a tension of the corresponding one of the plurality of cables, and wherein the method further comprises operating the anchor motor of each of the plurality of anchor assemblies to rotate the drum of the respective anchor assembly based on the measured torque.

28. The method of any one of the clauses herein, wherein the apparatus further includes a hopper coupled to the body portion, an arm assembly coupled to the body portion, and an end effector assembly coupled to the arm assembly, and wherein the method further comprises:
lifting, via the arm assembly and the end effector assembly, a surface material from the hopper; and
applying, via the arm assembly and the end effector assembly, the surface material onto the angled surface.

29. The method of any one of the clauses herein, wherein the apparatus further includes an arm assembly coupled to the body portion, and wherein the method further comprises:
lifting, via the arm assembly, an end effector assembly;
releasing, via the arm assembly, the end effector assembly; and
lifting, via the arm assembly, a hopper assembly.

30. The method of any one of the clauses herein, further comprising:
detecting, via one or more sensors coupled to the body portion, at least one pattern on at least one of the plurality of anchor assemblies; and
determining a position and/or orientation of the body portion relative to the at least one of the plurality of anchor assemblies based at least in part on the detected at least one pattern.

### VI. CONCLUSION

It will be apparent to those having skill in the art that changes may be made to the details of the above-described embodiments without departing from the underlying principles of the present disclosure. In some cases, well known structures and functions have not been shown or described in detail to avoid unnecessarily obscuring the description of the embodiments of the present technology. Although steps of methods may be presented herein in a particular order, alternative embodiments may perform the steps in a different order. Similarly, certain aspects of the present technology disclosed in the context of particular embodiments can be combined or eliminated in other embodiments. Furthermore, while advantages associated with certain embodiments of the present technology may have been disclosed in the context of those embodiments, other embodiments can also exhibit such advantages, and not all embodiments need necessarily exhibit such advantages or other advantages disclosed herein to fall within the scope of the technology. Accordingly, the disclosure and associated technology can encompass other embodiments not expressly shown or described herein, and the invention is not limited except as by the appended claims.

To the extent any material incorporated herein by reference conflicts with the present disclosure, the present disclosure controls. Where the context permits, singular or plural terms may also include the plural or singular term, respectively. For example, throughout this disclosure, the singular terms “a,” “an,” and “the” include plural referents unless the context clearly indicates otherwise. Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Furthermore, as used herein, the phrase “and/or” as in “A and/or B” refers to A alone, B alone, and both A and B. Additionally, the terms “comprising,” “including,” “having,” and “with” are used throughout to mean including at least the recited feature(s) such that any greater number of the same features and/or additional types of other features are not precluded. Moreover, as used herein, the phrases “based on,” “depends on,” “as a result of,” and “in response to” shall not be construed as a reference to a closed set of conditions. For example, a step that is described as “based on condition A” may be based on both condition A and condition B without departing from the scope of the present disclosure. In other words, as used herein, the phrase “based on” shall be construed in the same manner as the phrase “based at least in part on” or the phrase “based at least partially on.”

Reference herein to “one embodiment,” “an embodiment,” “some embodiments” or similar formulations means that a particular feature, structure, operation, or characteristic described in connection with the embodiment can be included in at least one embodiment of the present technology. Thus, the appearances of such phrases or formulations herein are not necessarily all referring to the same embodiment. Furthermore, various particular features, structures, operations, or characteristics may be combined in any suitable manner in one or more embodiments.

Unless otherwise indicated, all numbers expressing numerical values used in the specification and claims, are to be understood as being modified in all instances by the term “about.” Accordingly, unless indicated to the contrary, the numerical parameters set forth in the specification and attached claims are approximations that may vary depending upon the desired properties sought to be obtained by the present technology. At the very least, and not as an attempt to limit the application of the doctrine of equivalents to the scope of the claims, each numerical parameter should at least be construed in light of the number of reported significant digits and by applying ordinary rounding techniques. The terms “about,” “approximately,” and “substantially” as used herein shall be interpreted to mean within ÷10% of the stated value. Additionally, all ranges disclosed herein are to be understood to encompass the endpoints, and any and all subranges subsumed therein. For example, a range of “1 to 10” includes any and all subranges between (and including) the minimum value of 1 and the maximum value of 10 (e.g., any and all subranges having a minimum value of equal to or greater than 1 and a maximum value of equal to or less than 10, such as 5.5 to 10).

The disclosure set forth above is not to be interpreted as reflecting an intention that any claim or example requires more features than those expressly recited in that claim or example. Rather, as the preceding examples and the following claims reflect, inventive aspects lie in a combination of fewer than all features of any single foregoing disclosed embodiment. Thus, the preceding examples and the following claims are hereby expressly incorporated into the Detailed Description, with each claim standing on its own as a separate embodiment. This disclosure includes all permutations of the independent claims with their dependent claims.

What is claimed is:

1. An apparatus configured to operate on an angled surface relative to a direction of gravity, the apparatus comprising:
a body assembly including:
a body portion,
one or more wheels coupled to the body portion, one or more motors coupled to corresponding ones of the one or more wheels, wherein the one or more motors are configured to operate the one or more wheels to move the apparatus on the angled surface,
a plurality of cable connectors coupled to the body portion, wherein individual ones of the cable connectors are configured to be coupled to corresponding cables;
an arm assembly having a proximal end portion coupled to the body portion of the body assembly and a distal end portion opposite the proximal end portion, wherein the arm assembly includes a retriever at the distal end portion; and
an end effector assembly releasably coupled to the retriever of the arm assembly, wherein the end effector assembly is configured to carry a surface material.

2. The apparatus of claim 1, wherein the body assembly does not include a cable management assembly configured to reel a cable.

3. The apparatus of claim 1, wherein the body assembly further includes a rail fixedly coupled to the body portion, wherein the plurality of cable connectors are each slidably coupled to the rail.

4. The apparatus of claim 3, wherein the rail is shaped such that, when the cables coupled to the cable connectors are under tension, the cables extend along a plurality of axes that intersect at a common point in the body assembly.

5. The apparatus of claim 1, wherein the body assembly further includes one or more motor housings coupled to an external surface of the body portion and extending radially outward from the body portion, wherein the one or more motors are housed in corresponding ones of the one or more motor housings, and wherein the one or more wheels are coupled to distal ends of corresponding ones of the one or more motor housings.

6. The apparatus of claim 1, wherein the body assembly further includes one or more body sensors coupled to an external surface of the body portion and configured to measure at least one of a position or an orientation of the body portion relative to the angled surface.

7. The apparatus of claim 1, wherein the body assembly further includes:
one or more caster wheel arms coupled to an external surface of the body portion and extending away from the body portion; and
one or more caster wheels coupled to distal ends of corresponding ones of the one or more caster wheels arms.

8. The apparatus of claim 1, wherein the arm assembly further includes one or more retriever sensors coupled to the retriever.

9. The apparatus of claim 1, wherein the end effector assembly includes:
a main frame;
a bar coupled to the main frame and extending along a lateral axis;
a drive belt positioned adjacent to the bar and extending along the lateral axis;
a motor coupled to the main frame and operable to drive the drive belt; and
a tool support frame coupled to the bar and to the drive belt, wherein the tool support frame is configured to be releasably coupled to a tool operable to apply the surface material onto the angled surface.

10. The apparatus of claim 1, wherein the retriever includes a first pair of quick disconnect tools spaced apart from one another by a distance, and wherein the end effector assembly includes a second pair of quick disconnect tools spaced apart from one another by the distance such that the end effector assembly can be releasably coupled to the retriever of the arm assembly by engaging the first pair of quick disconnect tools with corresponding ones of the second pair of quick disconnect tools.

11. The apparatus of claim 1, wherein the end effector assembly includes:
a main frame;
a first actuator coupled to the main frame;
a pusher rod coupled to the first actuator, wherein the first actuator is configured to move the pusher rod to press the surface material against the angled surface;
a second actuator movably coupled to the main frame; and
a suction cup coupled to the second actuator, wherein the second actuator is configured to move the suction cup to engage the surface material.

12. The apparatus of claim 1, further comprising a hopper assembly including:
a hopper releasably coupled to the body portion of the body assembly, wherein the hopper is configured to store the surface material; and
a cutting tool coupled to a side of the hopper, wherein the cutting tool is configured to cut through the surface material.

13. The apparatus of claim 1, further comprising a hopper assembly including:
a hopper releasably coupled to the body portion of the body assembly, wherein the hopper is configured to store the surface material; and
a first pair of quick disconnect tools coupled to the hopper and spaced apart from one another by a distance,
wherein the retriever includes a second pair of quick disconnect tools spaced apart from one another by the distance such that the hopper can be releasably coupled to the retriever of the arm assembly by engaging the first pair of quick disconnect tools with corresponding ones of the second pair of quick disconnect tools.

14. A system for operating a device on an angled surface, the system comprising:
an apparatus configured to operate on the angled surface, the apparatus including:
a body assembly including a body portion, wheel legs coupled to and extending outward from the body portion, and wheels coupled to corresponding ones of the wheel legs, wherein the wheel legs are aligned with one another along a wheel axis;
an arm assembly having a proximal end portion coupled to the body portion of the body assembly and a distal end portion opposite the proximal end portion, wherein the arm assembly includes a retriever at the distal end portion; and
an end effector assembly releasably coupled to the retriever of the arm assembly, wherein the end effector assembly is configured to carry a shingle.

15. The system of claim 14, wherein the body assembly further includes motors configured to drive corresponding ones of the wheels.

16. The system of claim 14, wherein the body assembly further includes:
a rail fixedly coupled to the body portion;
a plurality of cable connectors each slidably coupled to the rail and configured to be coupled to corresponding cables,
wherein the rail is shaped such that when the cables coupled to the cable connectors are under tension, the cables extend along a plurality of axes that intersect with one another at a common point in the body assembly and with the wheel axis.

17. The system of claim 14, further comprising:
a plurality of anchor assemblies configured to be attached to the angled surface along a periphery thereof, wherein each of the plurality of anchor assemblies includes a base, a drum rotatably coupled to the base, and an anchor motor operably coupled to the drum and configured to rotate the drum relative to the base;
a plurality of cables each wound around the drum of a corresponding one of the plurality of anchor assemblies and coupled to the body assembly of the apparatus; and
a controller operably coupled to the plurality of anchor assemblies, wherein the controller is configured to, for each of the plurality of anchor assemblies, operate the anchor motor such that (i) the drum rotates to wind or unwind the corresponding one of the plurality of cables and (ii) the corresponding one of the plurality of cables remains under tension and extends between the anchor assembly and the body assembly of the apparatus.

18. The system of claim 17, wherein the anchor motor of each of the plurality of anchor assemblies comprises a servo motor housed in the base, and wherein each of the plurality of anchor assemblies further includes:
a ring gear coupled to an inner surface of the drum;
a sun gear engaged with the ring gear; and
a gear box coupled between the servo motor and the sun gear, wherein the gear box is configured to provide a gear reduction ratio of at least 20:1.

19. The system of claim 17, wherein each of the plurality of anchor assemblies further includes a sensor configured to measure a torque applied on the drum of the respective anchor assembly, wherein the measured torque indicates a tension of the corresponding one of the plurality of cables, and wherein the controller is operably coupled to the sensor and configured to operate the anchor motor of each of the plurality of anchor assemblies based on the torque measured by the respective sensor.

20. The system of claim 17, wherein the base of each of the plurality of anchor assemblies includes a pattern, and wherein the body assembly further includes one or more sensors coupled to the body portion and configured to detect the pattern and thereby determine a position of the body portion relative to the respective anchor assembly.

21. The system of claim 14, further comprising spacers each configured to contact a surface material and including at least one aperture, wherein the end effector assembly includes:
a plurality of gripper pins shaped and sized to fit at least partially in one of the at least one aperture of the pair of spacers; and
a plurality of actuators operably coupled to corresponding ones of the plurality gripper pins, wherein each of the plurality of actuators is configured to move the corresponding gripper pin to engage the one of the at least one aperture, thereby enabling the arm assembly and the end effector assembly to lift the spacers and the surface material.

22. The system of claim 14, further comprising a plurality of cables each movably coupled to the body assembly of the apparatus.

23. The system of claim 14, further comprising:
a plurality of anchors assemblies configured to be attached to the angled surface, wherein the plurality of anchors assemblies each includes a sensor; and
a plurality of cables extending between the body assembly of the apparatus and corresponding ones of the plurality of anchor assemblies,
wherein the sensor of each anchor assembly is configured to output a value characterizing a tension of a corresponding one of the cables.

24. A method of operating an apparatus to place surface materials on an angled surface, the method comprising:
attaching a plurality of anchor assemblies on the angled surface, wherein individual anchor assemblies includes a base, a drum rotatably coupled to the base, and an anchor motor operably coupled to the drum and configured to rotate the drum relative to the base;
providing an apparatus on the angled surface, wherein the apparatus includes:
a body portion,
one or more wheels coupled to the body portion,
one or more apparatus motors operably coupled to corresponding ones of the one or more wheels, and
a plurality of cable connectors coupled to the body portion, wherein the apparatus is coupled to the plurality of anchor assemblies via a plurality of cables each extending between a corresponding one of the plurality of anchor assemblies and a corresponding one of the plurality of cable connectors; and
operating the one or more apparatus motors to rotate the one or more wheels, such that the apparatus moves along the angled surface.

25. The method of claim 24, further comprising operating the anchor motor of each of the plurality of anchor assemblies to rotate the drum of the respective anchor assembly and thereby wind or unwind the corresponding one of the plurality of cables such that the plurality of cables remains under tension.

26. The method of claim 24, wherein attaching the plurality of anchor assemblies comprises attaching a first one of the plurality of anchor assemblies to a first portion of the angled surface, attaching a second one of the plurality of anchor assemblies to a second portion of the angled surface spaced apart from the first portion, and attaching a third one of the plurality of anchor assemblies to third portion of the angled surface spaced apart from the second portion.

27. The method of claim 24, wherein each of the plurality of anchor assemblies further includes a sensor configured to measure a torque applied on the drum of the respective anchor assembly, wherein the measured torque indicates a tension of the corresponding one of the plurality of cables, and wherein the method further comprises operating the anchor motor of each of the plurality of anchor assemblies to rotate the drum of the respective anchor assembly based on the measured torque.

28. The method of claim 24, wherein the apparatus further includes a hopper coupled to the body portion, an arm assembly coupled to the body portion, and an end effector assembly coupled to the arm assembly, and wherein the method further comprises:
lifting, via the arm assembly and the end effector assembly, a surface material from the hopper; and
applying, via the arm assembly and the end effector assembly, the surface material onto the angled surface.

29. The method of claim 24, wherein the apparatus further includes an arm assembly coupled to the body portion, and wherein the method further comprises:
lifting, via the arm assembly, an end effector assembly;
releasing, via the arm assembly, the end effector assembly; and
lifting, via the arm assembly, a hopper assembly.

30. The method of claim 24, further comprising:
detecting, via one or more sensors coupled to the body portion, at least one pattern on at least one of the plurality of anchor assemblies; and
determining a position and/or orientation of the body portion relative to the at least one of the plurality of anchor assemblies based at least in part on the detected at least one pattern.
